(19) United States
(12) Patent Application Publication
(10) Pub. No.: US 2025/0181296 A1
(43) Pub. Date: Jun. 5, 2025

(54) METHOD AND APPARATUS FOR CONTROLLING USER TERMINAL ON BASIS OF USER TERMINAL BEING POSITIONED IN PRESET CUSTOM AREA

(71) Applicant: NAVER CORPORATION, Seongnam-si (KR)

(72) Inventors: Jeanie JUNG, Seongnam-si (KR); Sangwook KIM, Seongnam-si (KR); Yeowon YOON, Seongnam-si (KR); Kihyun YU, Seongnam-si (KR); Jongjin PARK, Seongnam-si (KR)

(73) Assignee: NAVER CORPORATION, Seongnam-si (KR)

(21) Appl. No.: 19/050,911

(22) Filed: Feb. 11, 2025

Related U.S. Application Data
(63) Continuation of application No. PCT/KR2023/000271, filed on Jan. 6, 2023.

(30) Foreign Application Priority Data
Aug. 12, 2022 (KR) 10-2022-0101100

(51) Int. Cl. G06F 3/14; G01C 21/20

(52) U.S. Cl. CPC G06F 3/14; G01C 21/206

(57) ABSTRACT

A method of controlling a user terminal, performed by a computer system that is a server or the user terminal, may include determining whether the user terminal is located within a customized region of a space based on a location of the user terminal, the customized region being associated with at least one service element, and in response that the user terminal is determined to be located in the customized region, controlling the user terminal based on the service element.

### CROSS-REFERENCE TO RELATED APPLICATIONS

This U.S. non-provisional application is a continuation of and claims the benefit of priority under 35 U.S.C. § 365 (c) to International Application PCT/KR2023/000271, which has an International filing date of Jan. 6, 2023 and claims priority to Korean Patent Application No. 10-2022-0101100, filed Aug. 12, 2022, the entire contents of each of which are incorporated herein by reference in their entirety.

### BACKGROUND

### Technical Field

The following description relates to methods and apparatuses for controlling a user terminal based on a location of the user terminal, and more particularly, to methods and apparatuses for controlling a user terminal, such as a defining a customized region associated with a service element on a map of space and providing content to the user terminal in response to the user terminal being located in the customized region.

### Related Art

Augmented reality (AR) refers to technology that integrates and complements virtual objects and information created with computer technology in the real world. That is, augmented reality refers to technology that augments and displays virtual content in a real environment, and a user may view augmented content corresponding to a real environment through an electronic device.

Through a user terminal that is the electronic device of the user, content associated with an object present at a desired (or alternatively, predetermined) distance or within a desired (or alternatively, predetermined) radius based on a location of the user terminal is augmented on a video of the user terminal and thereby provided. As such, when augmented content is provided only based on a physical distance from the user terminal, an unnecessarily large amount of content could be augmented, and thus increases the user's cognitive load and/or load on the user terminal. Further, there may be cases in which content unsuitable for a service intended by the user is inappropriately augmented on the user terminal.

As technology related to various services utilizing augmented reality technology, for example, an augmented reality navigator may display a video of a driving route captured by a camera installed in a vehicle, and map and display virtual display information guiding the driving route on the video displayed on a display

The information described above is simply provided to help understanding, and may include content that does not form the part of the related art and may not include what the related art may present to one skilled in the art.

### SUMMARY

Some example embodiments may provide methods of controlling a user terminal that may determine whether the user terminal is located in a desired or preset customized region within space and controls the user terminal to display augmented reality (AR) content, to provide a user interface (UI), and/or to control settings of the user terminal, based on a service element associated with the customized region.

Some example embodiments may create a customized region for controlling a user terminal according to a scenario condition by defining the customized region as a two-dimensional (2D) space or a three-dimensional (3D) space on a map of space, by associating a service element with the customized region, and by defining the scenario condition for providing a service or information associated with the space based on the service element or controlling settings of the user terminal.

Some example embodiments may provide methods of controlling a user terminal such that different content may be provided to the user terminal, a different UI may be provided to the user terminal, or settings of the user terminal may be differently controlled, depending on a scenario condition defined in a customized region, for the user terminal that enters or exits the customized region.

According to an example embodiment, a method of controlling a user terminal, performed by a computer system that is a server or the user terminal, may include determining whether the user terminal is located within a customized region of a space based on a location of the user terminal, the customized region being associated with at least one service element, and in response that the user terminal is determined to be located in the customized region, controlling the user terminal based on the service element.

The method may further include defining the customized region to include at least one of two-dimensional (2D) space or three-dimensional (3D) space on a map of the space, wherein the controlling of the user terminal may include controlling the user terminal based on the service element when the location of the user terminal is present in the customized region on the map.

The customized region may include 3D space with a 2D area and a height range, and the controlling of the user terminal may include, when the user terminal is located in the 2D area and a height of the user terminal belongs to the height range, determining that the user terminal is located in the customized region and controlling the user terminal based on the service element.

The method may further include defining a 3 degree of freedom (DoF) or a 6DoF posture condition of the user terminal in the customized region, wherein the controlling of the user terminal may include, when the user terminal is determined to be located in the customized region, controlling the user terminal based on the service element if posture of the user terminal satisfies at least one of the 3Dof posture condition or the 6DoF posture condition.

The method may further include defining are least one condition among a first condition representing a time condition, a second condition representing movement of the user terminal, and a third condition representing manipulation of the user terminal in the customized region, wherein the controlling of the user terminal may include, when the user terminal is determined to be located in the customized region, controlling the user terminal based on the service element if the user terminal satisfies the defied condition.

The service element may include data for displaying augmented reality (AR) content related to a service associated with the space, and the controlling of the user terminal may include, in response to the user terminal being located in the customized region, displaying the AR content through an AR view that includes a video captured by a camera of the user terminal based on the service element.

The AR content may be associated with a first object located in the customized region and displayed within the AR view corresponding to the customized region, or the AR content may be associated with a second object located in a remote area for the customized region and displayed within the AR view corresponding to the remote area.

The AR content may include a plurality of sequences, and the displaying of the AR content may include, when the user terminal is determined to be located within the customized region, displaying different sequences of the AR content through the AR view according to a location of the user terminal within the customized region.

The displaying of the AR content may include changing and thereby displaying the AR content displayed through the AR view or outputting additional content, based on at least one of the location of the user terminal within the customized region, the number of entries of the user terminal into the customized region, or an entry and exit status of the user terminal for the customized region.

When the user terminal enters the customized region and when the user terminal leaves the customized region, the displaying of the AR content comprises displaying different AR content as the AR content through the AR view.

The service element may include data for displaying map element content related to a service associated with the space, and the controlling of the user terminal may include, in response to the user terminal being located in the customized region, displaying the map element content through a map view that includes a map including the location of the user terminal, based on the service element.

The map element content may be associated with a first object located in the customized region and displayed in an area corresponding to the customized region of the map view, or may be associated with a second object located in a remote area for the customized region and displayed in an area corresponding to the remote area of the map view.

The service element may include data for displaying a user interface (UI) related to a service associated with the space, and the controlling of the user terminal may include, in response to the user terminal entering the customized region or in response to the user terminal leaving the customized region, displaying the UI on the user terminal based on the service element.

The service element may include data for controlling settings of the user terminal to provide a service associated with the space to the user terminal, and the controlling of the user terminal may include, in response to the user terminal entering the customized region or in response to the user terminal leaving the customized region, controlling the settings of the user terminal based on the service element.

The controlling of the settings of the user terminal may include running a module for recognizing an object within the space or the customized region or suspending running of the module.

A scenario condition for providing a service or information associated with the space to the user terminal based on the service element or controlling settings of the user terminal based on the service element may be defined in the customized region, and the controlling of the user terminal may include controlling the user terminal such that the service or the information associated with the space is provided to the user terminal based on the service element or the settings of the user terminal, according to the scenario condition.

A plurality of customized regions may be set in the space, and the scenario condition may be defined in the customized region to differently provide the service or the information associated with the space to the user terminal based on the service element or to differently control the settings of the user terminal, depending on whether at least one scenario condition is satisfied between i) a first scenario condition representing whether the user terminal has passed through another customized region rather than the customized region and ii) a second scenario condition representing whether a number of user terminals located in the customized region corresponds to a range.

The service element associated with the customized region may include a plurality of service elements, the plurality of service elements may be associated with different points within the customized region, respectively, and in the customized region, the scenario condition may be defined to differently provide the service or the information associated with the space in order in which the user terminal passes through a point associated with each of the plurality of service elements.

The method of controlling the user terminal may further include receiving, from the user terminal, a route guidance request to a destination; and providing a route guidance to the user terminal in response to the route guidance request. The determining and the controlling of the user terminal may be performed when the user terminal moves to the destination according to the route guidance.

According to an example embodiment, there is provided a computer system that implements a user terminal or a server, the computer system including at least one processor configured to execute computer-readable instructions included in a memory, wherein the at least one processor is configured to determine whether the user terminal is located within a customized region based on a location of the user terminal, the customized region being associated with at least one service element, and in response that the user terminal is determined to be located in the customized region, control the user terminal based on the service element.

By defining a customized region as two-dimensional (2D) space or three-dimensional (3D) space on a map of space, by associating a service element with the customized region, and by defining a scenario condition for providing a service or information associated with the space, based on the service element or controlling settings of the user terminal based on the service element, it is possible to create the customized region for controlling the user terminal according to the scenario condition.

By setting a customized region in consideration of an occlusion area for a user terminal within space and by displaying augmented reality (AR) content on the user terminal depending on whether the user terminal enters or exits the customized region, it is possible to implement an AR view for displaying the AR content with improved performance on the user terminal.

By allowing individual service elements to be associated with a customized region, even customized regions overlapping in space may be properly controlled by a user terminal although the customized regions are defined.

By defining a customized region as 3D space, a scenario condition that considers a height or posture of a user terminal may be used to determine whether the user terminal enters or exits the customized region and whether to control the user terminal.

For a user terminal that enters or exits a customized region, it is possible to provide different content to a user terminal, to provide a different UI to the user terminal, or to differently control settings of the user terminal, depending on a scenario condition defined in the customized region (e.g., relationship with another customized region and/or the number of user terminals located in the customized region).

### BRIEF DESCRIPTION OF DRAWINGS

FIG. 1 illustrates a method of controlling a user terminal in response to the user terminal being located in a desired (or alternatively, preset) customized region according to an example embodiment.

FIG. 2 illustrates a computer system configured to perform a method of controlling a user terminal according to an example embodiment.

FIG. 3 is a flowchart illustrating a method of controlling a user terminal by determining whether the user terminal is located in a desired (or alternatively, preset) customized region according to an example embodiment.

FIG. 4 is a flowchart illustrating a method of controlling a user terminal based on a service element associated with a customized region according to an example embodiment.

FIG. 5 is a flowchart illustrating a method of creating a customized region according to an example embodiment.

FIG. 6 illustrates a map in which a customized region is defined according to an example embodiment.

FIG. 7 illustrates a map in which a customized region is defined and an augmented reality (AR) view screen of a user terminal according to an example embodiment.

FIG. 8A illustrates a customized region defined as three-dimensional (3D) space according to an example embodiment.

FIG. 8B illustrates degree of freedom (DoF) of a user terminal according to an example embodiment.

FIG. 9 illustrates a method of displaying AR content or map element content associated with an object of a remote area on a user terminal in response to the user terminal being located in a desired (or alternatively, preset) customized region according to an example embodiment.

FIGS. 10 and 11 illustrate a method of displaying a user interface (UI) on a user terminal in response to the user terminal being located in a desired (or alternatively, preset) customized region according to an example embodiment.

FIGS. 12 and 13 illustrate a method of displaying route guidance information through a map view of a user terminal according to an example embodiment.

FIG. 14 illustrates a customized region including a plurality of points according to an example embodiment.

FIG. 15 illustrates a method of controlling settings of a user terminal in response to the user terminal being located in a desired (or alternatively, preset) customized region according to an example embodiment.

FIG. 16 illustrates a method of setting a plurality of customized regions in space and setting a scenario condition for controlling a user terminal for each customized region according to an example embodiment.

FIGS. 17A to 21C illustrate a method of controlling a user terminal located in a customized region according to various scenario conditions defined for the customized region according to an example embodiment.

### DETAILED DESCRIPTION

Hereinafter, some example embodiments are described in detail with reference to the accompanying drawings.

As used herein, expressions such as “one of,” “any one of,” and “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

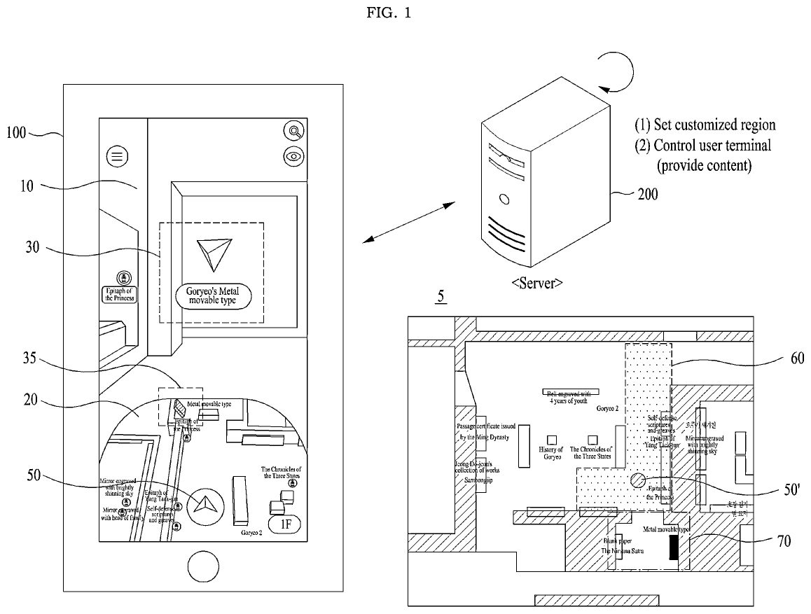

FIG. 1 illustrates a method of controlling a user terminal in response to the user terminal being located in a desired (or alternatively, preset) customized region according to an example embodiment.

“Control” of a user terminal 100 in example embodiments described below may include, for example, at least one of augmenting and displaying content (e.g., augmented reality (AR) content 30) representing a service or information associated with space 5 in a video of an AR view 10 using the AR view 10 of the user terminal 100 displaying a user interface (UI) related to the service associated with the space 5 on the user terminal 100 displaying map element content 35 related to the service associated with the space 5 on a map (or map view 20) of the user terminal 100 controlling settings of the user terminal 100 to provide the service associated with the space 5, as illustrated in FIG. 1. Also, “control” of the user terminal in example embodiments of the present disclosure may include functions and/or operations of the user terminal, which are not limited to the examples.

“Space 5” related to providing of augmented content in example embodiments may represent indoor space and/or outdoor space. That is, the space 5 described below may be defined as space that includes an indoor location or an outdoor location, and may also be defined as complex space in which the indoor space and the outdoor space are combined. The space 5 may be at least a portion of a service target area for providing services including provision of content.

In the following description, a location of a user possessing the user terminal 100 may also be described as a location of the user terminal 100 for clarity of description. Also, for clarity of description, “user” and “user terminal 100” possessed by the user may be interchangeably used.

In the following description, “augmenting and displaying” content and/or information (e.g., indicator) in a video may be interpreted to encompass overlappingly displaying the content and/or information on a video/screen of an AR view depending on example embodiments.

As illustrated, the user terminal 100, such as a smartphone, may capture surroundings using a camera, and may display the AR content 30 through the AR view 10 that includes a video captured by the camera. The AR content 30 may be associated with an object present within the space 5. This AR content 30 may be mapped to the corresponding object (or node representing the object).

At least one customized region may be defined on the map of the illustrated space 5 (or other data representing the space 5). In the illustrated example, a total of two customized regions, a first customized region 60 and a second customized region 70, are defined. At least one service element may be associated with each of the customized regions 60 and 70. Also, a scenario condition for providing the service or information associated with the space 5 based on a corresponding service element or controlling settings of the user terminal 100 may be defined in each of the customized regions 60 and 70. The service or information may also include information for advertising or marketing.

“Customized regions 60 and 70” may be set or preset on a server 200. For example, on the server 200, at least a partial area of the space 5 or a distinct partial area of the space 5 may be set as “customized region 60, 70”

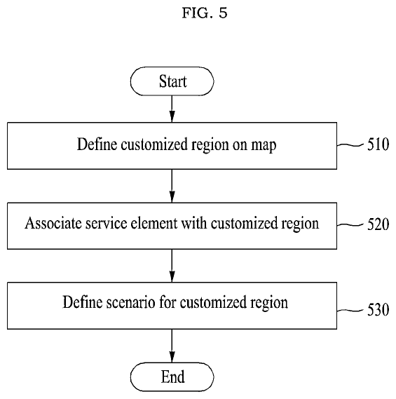

A method of defining each of the customized regions 60 and 70 and setting (creating) the customized region 60, 70 by associating a service element and a scenario condition with the customized region 60, 70 is further described below with reference to FIG. 5 and the like.

In an example embodiment, whether the user terminal 100 is located in the first customized region 60 within the space 5 may be determined based on a location of the user terminal 100, and when the user terminal 100 is determined to be located in the first customized region 60, the AR content 30 may be displayed on the AR view 10 of the user terminal 100 based on the service element associated with the customized region 60. For example, in response to the user terminal 100 entering the first customized region 60, the AR content 30 associated with object “Metal movable type” may be displayed on the AR view 10. Here, a current location 50 of the user terminal 100 may be displayed on the map view 20. The current location 50 may correspond to a location 50′ in the space 5. The illustrated example embodiment shows an example of displaying the AR content 30 associated with the object “Metal movable type” present outside the first customized region 60 when the user terminal 100 enters the first customized region 60. However, depending on the service element associated with the first customized region 60, when the user terminal 100 enters the first customized region 60, another AR content associated with an object present inside the first customized region 60, for example, “Epitaph of the Princess,” may be displayed.

Meanwhile, in another example embodiment, a different type of content may be displayed on the AR view 10, an appropriate user interface (UI) may be provided, appropriate map element content may be displayed, or settings of the user terminal 100 may be appropriately changed, according to the scenario condition defined in the first customized region 60, such as a case in which the user terminal 100 leaves the first customized region 60 based on the location of the user terminal 100.

The map view 20 displayed with the AR view 10 on the screen of the user terminal 100 may include a map that matches the video of the AR view 10. The map view 20 may include the current location 50 of the user terminal 100. The map view 20 may include a two-dimensional (2D) map or a three-dimensional (3D) map. The map view 20 may include an object within the space 5 in which the user terminal 100 moves. On the map view 20, the map element content 35 corresponding to the AR content 30 may be displayed. The map element content 35 may be displayed when the AR content 30 is displayed on the AR view 10, or when an object associated with the AR content 30 is included within the map view 20.

The user terminal 100 may communicate with the server 200 to control entry or exit into or from the customized region 60, 70. For example, the server 200 may control the user terminal 100 based on the service element associated with the customized region 60, 70 in which the user terminal 100 is located.

The server 200 refers to a computer system that manages the customized regions 60 and 70 defined for the space 5, and may be a server that manages association of service elements and definition of scenario conditions for the customized regions 60 and 70. Also, the server 200 may be a map server that provides a digital map (3D map and/or 2D).

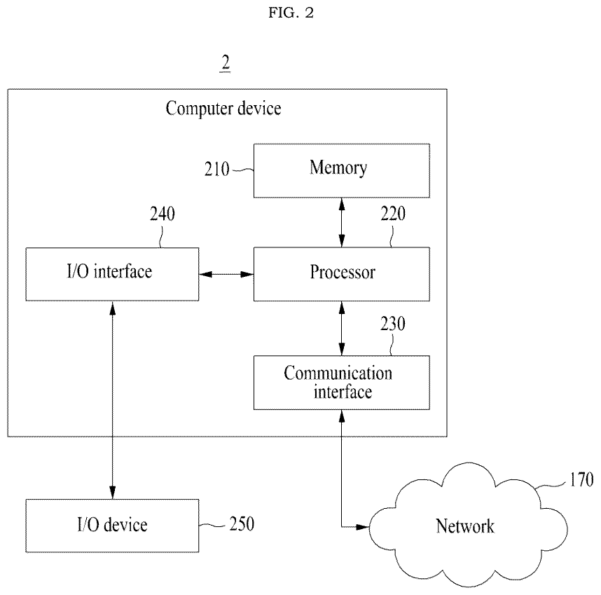

A method of controlling the user terminal 100 according to a location and/or entry or exit of the user terminal 100 for the customized region 60, 70 and a method of creating (configuring) the customized region 60, 70 by way of the user terminal 100 and/or the server 200 are further described below with reference to FIGS. 2 to 16.

FIG. 2 is a computer system that performs a method of controlling a user terminal according to an example embodiment.

The user terminal 100 described above with reference to FIG. 1 according to example embodiments may be implemented through an illustrated computer system 2. For example, a computer program for implementing the method of an example embodiment may be installed and run on the computer system 2. The computer system 2 may perform an augmented content providing method according to example embodiments under control of the running computer program.

The method of controlling the user terminal 100 according to example embodiments may be performed through a PC-based program or a mobile terminal-specific application. For example, the method of controlling the user terminal 100 according to example embodiments may be implemented in the form of a program that independently operates or may be configured in an in-app form of a specific application and implemented to be operable on the specific application. This specific application may be installed on, for example, the computer system 2 to provide the AR content 30 through the AR view 10, thereby performing the method of controlling the user terminal 100 of the example embodiment.

The computer system 2 may be an electronic device corresponding to the aforementioned user terminal 100, and may be a smartphone that may install and run an application or a program as shown in FIG. 1 and a device similar thereto. Also, the computer system 2 may be a personal computer (PC), a laptop computer, a tablet, an Internet of Things (IoT) device, or a wearable computer.

As illustrated, the computer system 2 may include a memory 210, a processor 220, a communication interface 230, and an input/output (I/O) interface 240 as components for performing the method of controlling the user terminal 100.

The memory 210 may include a permanent mass storage device, such as a random access memory (RAM), a read only memory (ROM), and a disk drive, as a computer-readable recording medium. Here, the permanent mass storage device, such as ROM and a disk drive, may be included in the computer system 2 as a permanent storage device separate from the memory 210. Also, an operating system (OS) and at least one program code may be stored in the memory 210. Such software components may be loaded to the memory 210 from another computer-readable recording medium separate from the memory 210. The other computer-readable recording medium may include a computer-readable recording medium, for example, a floppy drive, a disk, a tape, a DVD/CD-ROM drive, a memory card, etc. According to other example embodiments, software components may be loaded to the memory 210 through the communication interface 230, instead of the computer-readable recording medium. For example, the software components may be loaded to the memory 210 of the computer system 2 based on a computer program installed by files received over a network 170.

The processor 220 may be configured to process instructions of a computer program by performing basic arithmetic operations, logic operations, and I/O operations. The instructions may be provided from the memory 210 or the communication interface 230 to the processor 220. For example, the processor 220 may be configured to execute received instructions in response to the program code stored in the storage device, such as the memory 210.

That is, the processor 220 may manage the components of the computer system 2, and may execute a program or an application used by the computer system 2. For example, the processor 220 may be configured to execute an application for performing the method of controlling the user terminal 100 of the example embodiment and to process data received from the server 200 to control the user terminal 100 (e.g., data received from the server 200 to provide the AR content 30 through the AR view 10). Also, the processor 220 may process an operation to execute the program or the application and process data, and may be at least one processor of the computer system 2 or at least one core within the processor. The communication interface 230 may provide a function for communication between the communication system 2 and another computer system (not shown) over the network 170. For example, the processor 220 of the computer system 2 may deliver a request or an instruction created based on a program code stored in the storage device such as the memory 210, data, and a file, to other computer systems over the network 170 under control of the communication interface 230. Inversely, a signal, an instruction, data, a file, etc., from another computer system may be received at the computer system 2 through the network 170 and the communication interface 230 of the computer system 2. For example, a signal, an instruction, data, etc., received through the communication interface 230 may be delivered to the processor 220 or the memory 210, and a file, etc., may be stored in a storage medium (e.g., the permanent storage device) further includable in the computer system 2. For example, the communication interface 230 may be a hardware module such as a network interface card, a network interface chip, a networking interface port of the computer system 2, or a software module such as a network device driver or a networking program.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus (e.g., a touch screen) in which an input function and an output function are integrated into a single function. The I/O device 250 may be configured as a single apparatus with the computer system 2.

Also, in other example embodiments, the computer system 2 may include the number of components greater than or less than the number of components shown in FIG. 2. However, there is no need to clearly illustrate many components according to the related art. For example, the computer system 2 may be implemented to include at least some of I/O devices connected to the I/O interface 240 described above, or may further include other components such as a transceiver, a global positioning system (GPS) module, a camera, various sensors, and a database. In detail, for example, when the computer system 2 is implemented in the form of a mobile device such as a smartphone, various components may be implemented to be further included in the computer system 2, such as a camera, an acceleration sensor or a gyro sensor, various physical buttons, a button using a touch panel, an I/O port, and a vibrator for vibration that are generally included in the mobile device.

For example, the computer system 2 corresponding to the user terminal 100 may include a camera that captures surroundings to run the AR view 10. The computer system 2 may display a video captured through the camera as the AR view 10, and may augment and thereby display the AR content 30 in the video of the AR view 10. For example, the computer system 2 may determine whether the user terminal 100 is located in the desired (or alternatively, preset) customized region 60, 70 according to positioning, and when the user terminal 100 is located in the customized region 60, 70, may display, on the AR view 10, the AR content 30 based on the service element associated with the customized region 60, 70. A method by visual localization or a Visual Positioning System (VPS) may be used for positioning of the user terminal 100. Alternatively, a method by recognizing a marker, a method of using a GPS, a method of using a Wi-Fi Positioning System (WPS), a method of a Bluetooth module, and a method of using odometry may be used for positioning of the user terminal 100.

Meanwhile, an actual operation of determining whether the computer system 2 is located in the customized region 60, 70 may also be performed by the server 200 rather than the computer system 2. The server 200 may be an electronic device that communicates with the computer system 2 to provide data for controlling the user terminal 100 to the computer system 2, thereby controlling the user terminal 100. The server 200 may include a database as a device that manages (register, change, delete, store, and maintain) data and content to be provided to the computer system 2, and the customized region 60, 70, or may communicate with this database. Also, the server 200 may be a map server that provides a digital map (3D map and/or 2D) or may include this map server.

The server 200 may include at least one computer system. The computer system included in the server 200 may include similar components to the computer system 2 described above, and further description related thereto is omitted.

In an example embodiment, the user terminal 100 that is the computer system 2 may be controlled based on data and/or information provided from the server 200 through communication with the server 200. Here, the server 200 may receive a location of the user terminal 100, may determine whether the user terminal 100 is located within the customized region 60, 70 based on the received location, and when the user terminal 100 is located in the customized region 60, 70, may control the user terminal 100 based on the service element associated with the corresponding customized region 60, 70.

In the detailed description to be described below, for clarity of description, example embodiments are described based on the computer system 2 corresponding to the user terminal 100 and description related to communication with the server 200 and operation on the side of the server 200 may be briefly made or omitted. Also, for clarity of description, operations (stages) performed by a component (e.g., processor) of the computer system 2 (or server 200) may be described to be performed by the computer system 2 (or server 200).

Description related to the technical features described above with reference to FIG. 1 may also be applied as is to FIG. 2 and thus repeated description is omitted.

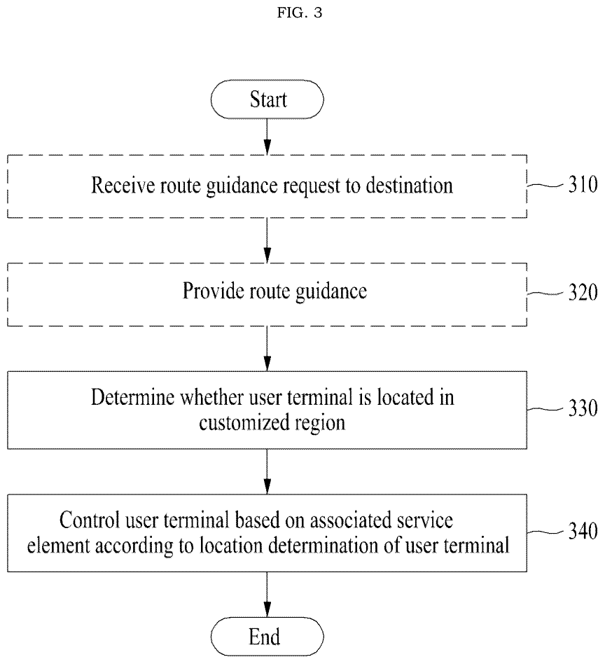

FIG. 3 is a flowchart illustrating a method of controlling a user terminal by determining whether the user terminal is located in a desired (or alternatively, preset) customized region according to an example embodiment.

A method of controlling the user terminal 100, performed by the computer system 2, is described with reference to FIG. 3. Because the computer system 2 may be the user terminal 100 described above with reference to FIG. 1, the following detailed description describes an example embodiment using the terms, the user terminal 100 and the server 200, instead of using the computer system 2.

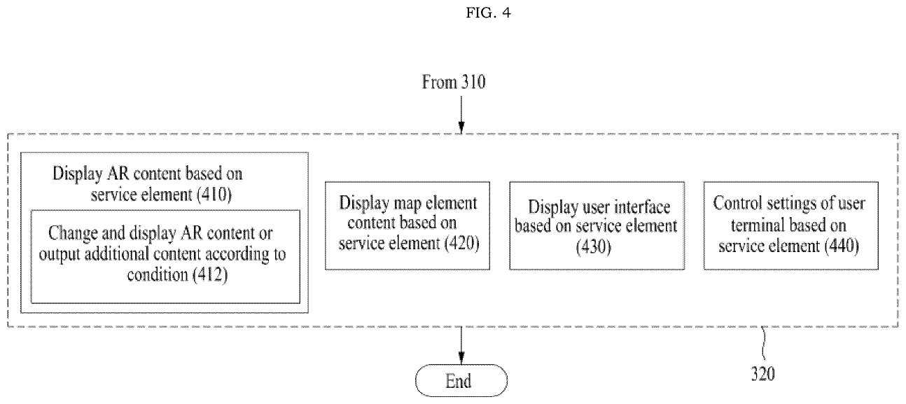

Also, at least a portion of the following operations 310 to 340 and operations described with reference to FIG. 4 may be configured to be performed not the user terminal 100 but the server 200. In the following, performing of operations is described based on the user terminal 100, and repeated description related to the server 200 may be omitted.

In operation 330, the user terminal 100 or the server 200 may determine whether the user terminal 100 is located in the desired (or alternatively, preset) customized region 60, 70 within the space 5, based on a location of the user terminal 100. The customized region 60, 70 may be associated with at least one service element. The user terminal 100 may determine the location of the user terminal 100 through a method based on, for example, at least one of GPS, VPS, WPS, may determine whether the user terminal 100 is located in the customized region 60, 70 based on the determined location, or may determine whether the user terminal 100 enters the customized region 60, 70 or leaves the customized region 60, 70. In some example embodiments, the server 200 may receive the determined location of the user terminal 100, and may determine whether the user terminal 100 is located in the customized region 60, 70 or enters or exits the customized region 60, 70 based on the received location.

In operation 340, as the user terminal 100 is determined to be located in the customized region 60, 70 (including the user terminal 100 leaving the customized region 60, 70), the user terminal 100 or the server 200 may control the user terminal based on the service element associated with the customized region 60, 70. That is, the user terminal 100 may be controlled to execute a specific operation based on data included in the service element associated with the customized region 60, 70.

“Control” of the user terminal 100 may include, for example, at least one of augmenting and displaying content (e.g., AR content 30) representing a service or information associated with the space 5 in the video of the AR view 10 using the AR view 10 of the user terminal 100, displaying a user interface (UI) related to the service associated with the space 5 on the user terminal 100, displaying the map element content 35 related to the service associated with the space 5 on a map (or map view 20) of the user terminal 100, and controlling settings of the user terminal 100 to provide the service associated with the space 5, as illustrated in FIG. 1.

In an example embodiment, a scenario condition for providing the service or information associated with the space 5 to the user terminal 100 based on the service element associated with the customized region 60, 70 or controlling settings of the user terminal 100 may be defined in the customized region 60, 70. The scenario condition may include a scenario condition for providing the service or information associated with the space 5 or controlling settings of the user terminal 100.

In operation 320 described above, the user terminal 100 or the server 200 may control the user terminal 100 such that the service or information associated with the space 5 may be provided to the user terminal 100 based on the service element associated with the customized region 60, 70, according to the scenario condition defined for the customized region 60, 70.

A method of controlling the user terminal 100 based on the service element associated with the customized region 60, 70 is further described below with reference to FIGS. 5 to 11 and FIGS. 14 to 16.

Meanwhile, the method of controlling the user terminal 100 of the example embodiment may be performed in combination with a route guidance service. For example, the method of controlling the user terminal 100 of the example embodiment may be performed in combination with an AR navigation that provides a route guidance indoors or outdoors.

In operation 310, the user terminal 100 may receive a route guidance request to a destination. For example, the user of the user terminal 100 may request the route guidance from the user terminal 100 by running an application or a program that provides an AR navigation service or other route guidance services and by entering the destination. The route guidance request may be delivered to the server 200 that provides the route guidance service.

In operation 320, the user terminal 100 may provide the route guidance in response to the route guidance request received in operation 310. For example, the user terminal 100 may receive data for route guidance to the destination from the server 200 that provides the route guidance service and may display information (e.g., guide information) for the route guidance to the destination based on the received data.

The user of the user terminal 100 may move to the destination along the route guidance. Here, operations 310 and 320 described above may be performed when the user terminal 100 moves to the destination along the route guidance.

For example, when the user terminal 100 moves to the destination along the route guidance, whether the user terminal 100 is located in the customized region 60, 70 may be determined and the user terminal 100 may be controlled based on the service element associated with the customized region 60, 70 according to the determination result.

Therefore, not only information for route guidance to the destination, but also additional information or service for the space or the customized region 60, 70 according to entry or exit into or from the desired (or alternatively, preset) customized region 60, 70 may be provided to the user terminal 100.

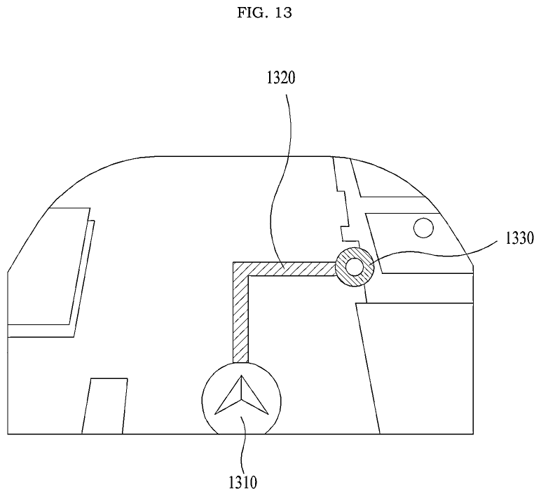

In this regard, FIGS. 12 and 13 illustrate a method of displaying route guidance information through a map view of a user terminal according to an example.

FIG. 13 illustrates an example of displaying information for route guidance on the map view 20 of the user terminal 100. Information for the route guidance may include a current location 1310 of the user terminal 100, a location 1330 of the destination, and a route 1320 through which the user terminal 100 needs to travel toward the destination. The location 1330 of the destination may be displayed only when the destination is included in the map view 20.

When the user terminal 100 moves to the destination according to information for the route guidance, the user terminal 100 may be controlled based on the service element associated with the customized region 60, 70 in response to the user terminal 100 being located in the customized region 60, 70. For example, when the user terminal 100 enters the customized region 60, 70, the AR content 30 may be displayed on the AR view 10 based on the service element associated with the customized region 60, 70, or predetermined map element content may be displayed within the map view 20 based on the service element.

Meanwhile, FIG. 12 illustrates an example of displaying information for route guidance through the AR view 10 of the user terminal 100.

FIG. 12 illustrates an example in which guide information 1200 is displayed on the AR view 10 as information for route guidance. The guide information 1200 may include information that may be referred to in order to reach a destination. For example, as illustrated, the guide information 1200 may include information on a location (3rd floor) to which the user needs to move from the user's current location (1st floor) to reach the destination.

Meanwhile, the guide information 1200 may be an example of content displayed on the user terminal 100 based on the service element associated with the desired (or alternatively, predetermined) customized region 60, 70.

That is, as illustrated, if the user terminal 100 that receives the route guidance to the destination enters the customized region 60, 70 that is an area near an elevator, the guide information 1200 for moving to the destination may be displayed on the user terminal 100 as information (or content) on riding the elevator based on a service element associated with the corresponding customized region.

Meanwhile, when the user terminal 100 enters the customized region 60, 70, content displayed on the user terminal 100 based on the service element may differ depending on a scenario condition defined in the customized region 60, 70. For example, when the user terminal 100 enters the customized region 60, 70, the guide information 1200 for moving to the destination may be displayed on the user terminal 100 if the user terminal 100 requests route guidance and is moving to the destination. However, if the user terminal 100 does not request the route guidance, general information related to a service provided from space or the customized region 60, 70 may be displayed on the user terminal 100. As in the illustrated example, if the customized region 60, 70 is an area near the elevator, the general information may include description information describing the elevator or information such as “Please take the elevator.”

An example in which the user terminal 100 is controlled based on the service element associated with and the scenario condition defined in the customized region 60, 70 is further described with reference to the accompanying drawings.

Description related to the technical features described above with reference to FIGS. 1 and 2 may also be applied as is to FIGS. 3, 12, and 13 and thus repeated description is omitted.

FIG. 4 is a flowchart illustrating a method of controlling a user terminal based on a service element associated with a customized region according to an example.

A method of providing AR content to the user terminal 100 is described as an example of controlling the user terminal 100 in response to the user terminal 100 being located in the customized region 60, 70 with reference to operations 410 and 412.

A service element associated with the customized region 60, 70 may include data for displaying AR content related to a service associated with the space 5.

In operation 410, in response to the user terminal 100 being located in the customized region 60, 70, the user terminal 100 may display the AR content through the AR view 10 based on the service element. As described above with reference to FIG. 1, the AR content may be, for example, 3D content. To provide information on a real object present in the space 5, the AR content may be displayed at a location of the real object or around the location of the real object. For example, when the space 5 is a museum, the real object may be an exhibit that is displayed in the museum. In some example embodiments, the real object may be a transportation method provided in the space 5, for example, a transportation method such as stairs, an escalator, and an elevator, or may be a facility such as a restroom, a sign, a signboard, and an information center.

The AR content displayed on the user terminal 100 may be associated with a first object located in the customized region 60, 70, and may be displayed within the AR view 10 corresponding to the customized region 60, 70. For example, describing with reference to FIG. 1, when the user terminal 100 enters the first customized region 60, AR content associated with the first object (e.g., “Epitaph of the Princess”) included in the first customized region 60 may be displayed within the AR view 10.

In some example embodiments, the AR content displayed on the user terminal 100 may be associated with a second object located in a remote area for the customized region 60, 70, and may be displayed within the AR view 10 corresponding to the corresponding remote area. The remote area may be a customized region different from the customized region 60, 70. For example, describing with reference to FIG. 1, when the user terminal 100 enters the first customized region 60, the AR content 30 associated with a second object (e.g., “Metal movable type”) included in the second customized region 70 corresponding to the remote area, rather than the first customized region 60, may be displayed within the AR view 10. If the user terminal 100 enters the first customized region 60, the AR content 30 associated with the second object may be displayed in a direction in which the second customized region 70 is located within the AR view 10. Therefore, in this example embodiment, when the user terminal 100 enters a specific customized region, not only information on an object within the customized region but also an object present within the remote area may also be displayed as AR content within the AR view 10.

The AR content displayed on the user terminal 100 may include animation or a plurality of sequences.

In a case in which the AR content includes the plurality of sequences, when the user terminal 100 is determined to be located in the customized region 60, 70, the user terminal 100 may display a different sequence of the AR content through the AR view 10 depending on a location of the user terminal 100 within the customized region, in displaying the AR content based on the service element.

In a case in which the AR content includes the animation, when the user terminal 100 is determined to be located in the customized region 60, 70, the user terminal 100 may display a different scene of the animation through the AR view 10 depending on the location of the user terminal 100 within the customized region 60, 70, in displaying the AR content based on the service element.

For example, as the user terminal 100 is located at a point indicating entrance, a point indicating exit, or a specific point set or preset within the customized region 60, 70, each different scene or different sequence of the AR content may be displayed on the AR view 10, and the customized region 60, 70 may be configured with a scenario condition to provide this different scene or different sequence to the user terminal 100.

The scene or the sequence may represent a child/sub-animation of the animation or a child/sub-sequence of the AR content.

In operation 412, the user terminal 100 may change and display the AR content or may output additional content through the AR view 10 according to the scenario condition predefined for the customized region 60, 70. For example, the user terminal 100 may change and display the AR content displayed through the AR view 10 or may output predetermined additional content, based on at least one of the location of the user terminal 100 within the customized region 60, 70, the number of entries of the user terminal 100 into the customized region 60, 70, the user terminal 100's entry and exit status for the customized region 60, 70.

For example, as the user terminal 100 is located at a point indicating entrance, a point indicating exit, or a specific point set or preset within the customized region 60, 70, the user terminal 100 may change and display the AR content or may output the additional content at each point. The customized region 60, 70 may be configured with the scenario condition to provide the changed AR content to the user terminal 100 or to output the additional content.

Also, by distinguishing between a case in which the user terminal 100 enters the customized region 60, 70 for the first time and a case in which the user terminal 100 enters the same for an n-th time (n=natural number greater than or equal to 2), the user terminal 100 may change and display the AR content or may output the additional content. The customized region 60, 70 may be configured with the scenario condition to provide the changed AR content to the user terminal 100 or to output the additional content. Here, the number of times the user terminal 100 enters the customized region 60, 70 may be counted only within a predetermined period of time (e.g., 1 hour or one day).

Also, by distinguishing between a case in which the user terminal 100 enters the customized region 60, 70 and a case in which the user terminal 100 leaves the customized region 100, the user terminal 100 may display different AR content through the AR view 10, or may output the additional content. The customized region 60, 70 may be configured with the scenario condition to provide the changed AR content to the user terminal 100 or to output the additional content. The additional content refers to content that may be output from the user terminal 100, and may be, for example, voice, text, image, and video.

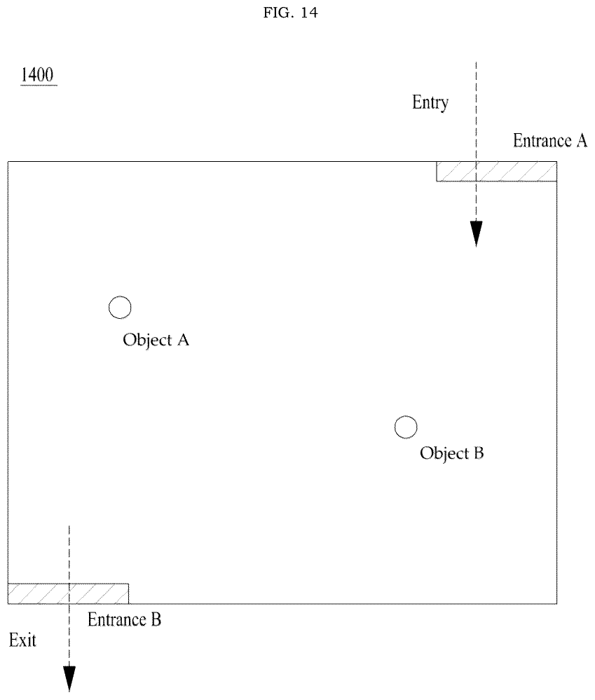

In this regard, FIG. 14 illustrates an example customized region. FIG. 14 illustrates a customized region including a plurality of points according to an example embodiment.

An illustrated customized region 1400 may be an area defined on a map of the space 5. The customized region 1400 may include a point indicate entrance A and a point indicating exit B. Also, the customized region 1400 may further include a point indicating an object A and a point indicating an object B. The user terminal 100 or the server 200 may determine that the user terminal 100 has entered the customized region 1400 or has exited the customized region 1400 by tracking a location of the user terminal 100. For example, based on a current location of the user terminal 100 and a route through which the user terminal 100 has already moved or will move, the user terminal 100 may be determined to have entered the customized region 60, 70, or to exit the customized region 60, 70. The user terminal 100 or the server 200 may verify through which node the user terminal 100 has already passed or through which node the user terminal 100 will pass based on the route and accordingly, may determine whether the user terminal 100 is present within the customized region or outside the customized region.

A plurality of service elements may be associated with the customized region 1400. Here, the plurality of service elements may be associated with different points within the customized region 1400, respectively. A scenario or a scenario condition defined in the customized region may be defined to differently provide a service or information associated with the space 5 according to order in which the user terminal 100 passes through the respective points associated with the respective service elements. The service or information differently provided may be AR content, or may be voice, text, image, and video that are content capable of being output from the user terminal 100 as other types of content.

For example, the scenario condition that causes the user terminal 100 to output a different type of content by distinguishing between a case in which the user terminal 100 enters the customized region 1400 and a case in which the user terminal 100 exits the customized region 1400 may be defined in the customized region 1400.

In some example embodiments, by distinguishing between a case in which the user terminal 100 enters through a specific point (e.g., at least one of points, entrance A, entrance B, object A, or object B) within the customized region 1400 and a case in which the user terminal passes through the specific point outside the customized region 1400 and then enters the customized region 1400, the scenario condition that causes the user terminal 100 to output a different type of content by identifying may be defined in the customized region 1400. For example, when the user terminal 100 enters the customized region 1400 through the point indicating entrance A, general welcome content may be output to the user terminal 100, but when the user terminal 100 enters the customized region 1400 through the point indicating entrance B, different content, for example, coupon content may be output to the user terminal 100. The coupon content may include discount coupons or benefits available within the space 5.

In some example embodiments, when the user terminal 100 enters the customized region 1400, a scenario condition that requests an additional action from the user terminal 100, such as a request for moving along edge of the customized region 1400, and causes the user terminal 100 to output a different type of content as the action is performed may be defined in the customized region 140. A request for the additional action may be provided to the user terminal 100 in the form of content or a UI.

In some example embodiments, the scenario condition that causes specific content to be output to the user terminal 100 may be defined in the customized region 1400 when the user terminal 100 enters the customized region 1400 n or more number of times (n is a natural number greater than or equal to 2) by counting the number of times that the user terminal 100 enters the customized region 1400, or the scenario condition that causes specific content to be output to the user terminal 100 may be defined in the customized region 1400 when the user terminal 100 stays in the customized region 1400 for a desired (or alternatively, predetermined) period of time or more.

Meanwhile, when the user terminal 100 leaves (e.g., exits) the customized region 1400, all content displayed on the user terminal 100 may be hidden, that is, un-displayed. When the user terminal 100 leaves the customized region 1400, a desired (or alternatively, predetermined) notification sound may be output to the user terminal 100. In some example embodiments, when the user terminal 100 leaves the customized region 1400, AR content indicating that the user terminal 100 has left the customized region 1400 may be displayed on the AR view 10.

As such, in an example embodiment, whether the user terminal 100 enters or exits the customized region 1400 may be determined, and depending on the determination results, display of AR content (e.g., entry guide AR content augmentation for entry and exit guide AR content augmentation for exit) may be differently made, display of a UI may be differently made, display of map element content may be differently made, or settings of the user terminal 100 may be differently controlled.

In relation to displaying the AR content, various scenario conditions that may be defined in the customized region 1400 are described in more detail with reference to FIGS. 5 to 8.

Hereinafter, a method of providing map element content to the user terminal 100 is described as an example of controlling the user terminal 100 in response to the user terminal 100 being located in the customized region 60, 70 with reference to operation 420.

The service element associated with the customized region 60, 70 may include data for displaying the map element content related to the service associated with the space 5.

In operation 420, in response to the user terminal 100 being located in the customized region 60, 70, the map element content may be displayed through the map view 20 that includes a map with the location of the user terminal 100, based on the service element associated with the customized region 60, 70. The map element content may be content displayed through the map view 20 or the map displayed on the user terminal 100. The map element content may include text, image, and 3D content. For example, the map element content may be content for describing an object included in the map view 20 or the map, or highlighting and displaying the object, or may be effect applied to the object.

The map element content displayed on the user terminal 100 may be associated with the first object located in the customized region 60, 70 and may be displayed in an area corresponding to the customized region 60, 70 of the map view 20. For example, describing with reference to FIG. 1, when the user terminal 100 enters the first customized region 60, the map element content associated with the first object (e.g., “Epitaph of the Princess”) included in the first customized region 60 may be displayed within the map view 20 (not shown in FIG. 1).

In some example embodiments, the map element content displayed on the user terminal 100 may be associated with the second object located in the remote area for the customized region 60, 70, and may be displayed within an area corresponding to the remote area of the map view 20. The remote area may be a customized region different from the customized region 60, 70. For example, describing with reference to FIG. 1, when the user terminal 100 enters the first customized region 60, the map element content 35 associated with the second object (e.g., “Metal movable type”) included in the second customized region 70 corresponding to the remote area, rather than the first customized region 60, may be displayed within the map view 20. If the user terminal 100 enters the first customized region 60, the map element content 35 associated with the second object may be displayed in the second customized region 70 within the map view 20, for example, at a location of a specific object associated with the map element content 35 or the AR content 30 of the second customized region 70. Therefore, in this example embodiment, when the user terminal 100 enters a specific customized region, not only information on an object within the customized region but also an object present within the remote area may also be displayed as the map element content.

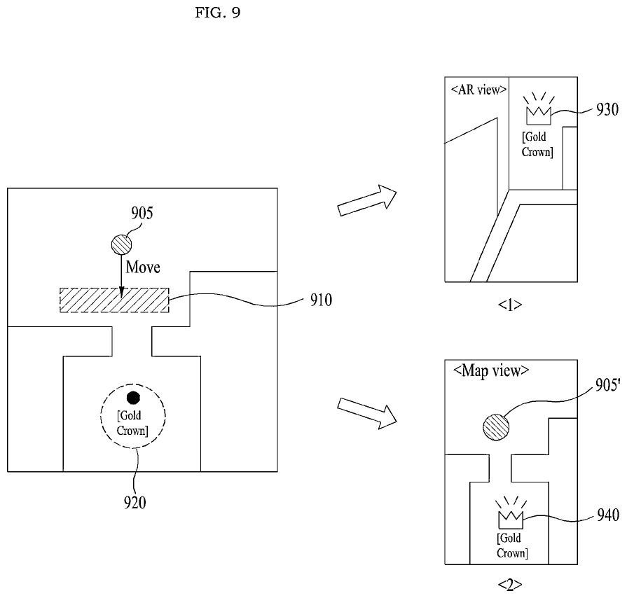

Hereinafter, a method of displaying AR content and map element content on the user terminal 100 is further described with reference to FIG. 9.

FIG. 9 illustrates a method of displaying AR content or map element content associated with an object of a remote area on a user terminal in response to the user terminal being located in a set or preset customized region according to an example embodiment.

In the illustrated example, a third customized region 910 and a fourth customized region 920 are defined on a map of a space. FIG. 9 illustrates a case in which the user terminal 100 moves from a location 905 to the third customized region 910.

The fourth customized region 920 may represent an area in which “Gold crown” is exhibited, and the third customized region 910 may represent an area near entrance of the Brass Room in which the corresponding gold crown is exhibited.

In an example embodiment, if the user terminal 100 enters the third customized region 910 from the location 905, the AR view 10 of the user terminal 100 may display AR content 930 representing the gold crown in a direction in which the gold crown, the object within the fourth customized region 920, is located (<1>). Also, the map view 20 of the user terminal 100 may display that the user terminal 100 is present at a location 905′ within the third customized region 910, and may also display map element content 940 representing the gold crown at a location of the gold crown that is the object within the fourth customized region 920 (<2>).

As such, in an example embodiment, a remote object or content absent in a specific customized region in terms of coordinates may be associated with the customized region, and when the user terminal 100 enters the customized region, information on the remote object or content may be displayed on the user terminal 100 as AR content and/or map element content.

Displaying the AR content 930 and/or the map element content 940 may refer to converting the corresponding content not displayed to displaying or to adding an additional effect (e.g., highlight effect or animation effect) to the content already being displayed.

As such, in an example embodiment, it is possible to improve the convenience of content provision in the AR view 10 and the map view 20.

Hereinafter, a method of providing a user interface (UI) to the user terminal 100 is described as an example of controlling the user terminal 100 in response to the user terminal 100 being located in the customized region 60, 70 with reference to operation 430.

The service element associated with the customized region 60, 70 may include data for displaying the user interface (UI) related to the service associated with the space 5.

In operation 430, as the user terminal 100 enters the customized region 60, 70, or as the user terminal 100 leaves the customized region, the user terminal 100 may display the UI on the user terminal 100 based on the service element associated with the customized region 60, 70. The UI may be a graphic user interface (GUI) displayed on the user terminal 100 to provide additional information in relation to the service provided in the space 5. The user terminal 100 may acquire additional information in relation to the service provided in the space 5 through interaction with the displayed UI.

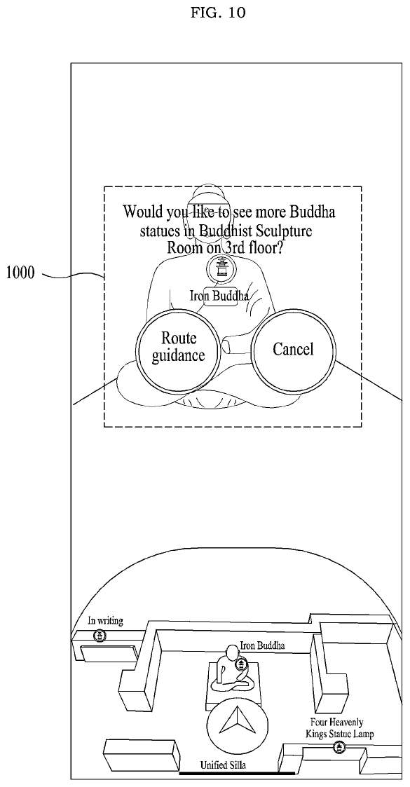

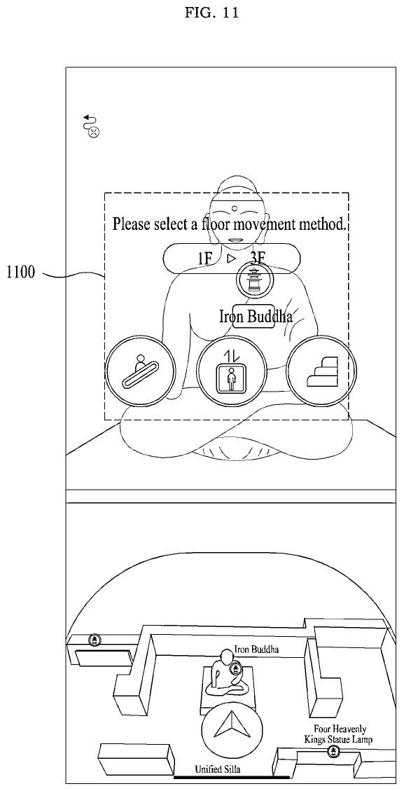

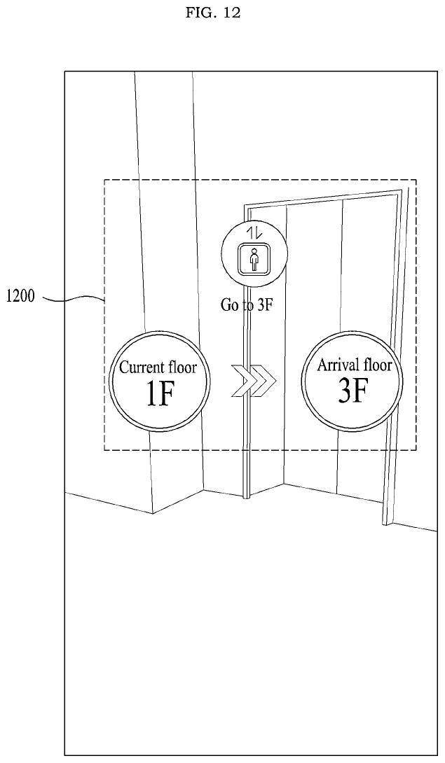

In this regard, FIGS. 10 and 11 illustrate a method of displaying a user interface (UI) on a user terminal in response to the user terminal being located in a set or preset customized region according to an example embodiment.

FIG. 10 illustrates a UI 1000 displayed through the AR view 10 of the user terminal 100 when the user terminal 100 enters a specific customized region.

The UI 1000 may be displayed along with content associated with “Iron Buddha” that is an object within the corresponding customized region, for example, together with AR content or after the AR content is displayed. The UI 1000 may be displayed on the user terminal 100 according to a scenario condition defined in the customized region, when the user terminal 100 enters the corresponding customized region. The UI 1000 may be displayed translucently for a video of the AR view 10.

In the illustrated example, if “cancel” is selected by the user terminal 100, displaying of the UI 1000 may be terminated. Meanwhile, if “route guidance” is selected by the user terminal 10, route guidance to another location or another object indicated by the UI 1000 may be provided to the user terminal 100. If “route guidance” is selected by the user terminal 10, a route to the other location or the other that is a destination may be displayed on the map view 20. In some example embodiments, if “route guidance” is selected by the user terminal 100, another UI may be further displayed on the user terminal prior to displaying the route.

In this regard, FIG. 11 illustrates an additional UI 1100 displayed through the AR view 10 of the user terminal 100 when a destination is located on a different floor during route guidance.

The additional UI 1100 may include UIs for selecting a method for moving between floors. The user terminal 100 may provide route guidance using the selected method and may display a corresponding route on the map view 20. The UI 1100 may be displayed translucently for a video of the AR view 10.

The user may move to the destination while verifying the route provided through the user terminal 100. Here, if the user enters the customized region 60, 70 that is an area near the elevator, the guide information 1200 for moving to the destination may be displayed on the user terminal 100 as information (or content) on riding the elevator based on the service element associated with the corresponding customized region, as illustrated in FIG. 12. As described above, the guide information 1200 may be displayed when the user terminal 100 requests the route guidance. The guide information 1200 may be displayed translucently for a video of the AR view 10.

In relation to displaying the UI, various scenario conditions that may be defined in the customized region 60, 70 are further described with reference to FIGS. 5 to 8 described below.

Hereinafter, a method of controlling settings of the user terminal 100 is described as an example of controlling the user terminal 100 in response to the user terminal 100 being located in the customized region 60, 70 with reference to operation 440.

The service element associated with the customized region 60, 70 may include data for controlling settings of the user terminal 100 to provide the service associated with the space 5.

In operation 440, as the user terminal 100 enters the customized region 60, 70, or as the user terminal 100 leaves the customized region 60, 70, settings of the user terminal 100 may be controlled based on the service element associated with the customized region 60, 70. Controlling the settings of the user terminal 100 may include controlling functions and/or operations of the user terminal 100 related to a service that may be provided to the user terminal 100 within the space 5. Controlling functions and/or operations may include turning on/off or enabling/disabling a corresponding function and/or operation.

For example, controlling the settings of the user terminal 100 may include running a module or suspending running of the module for recognizing an object within the space 5 or the customized region 60, 70 that the user terminal 100 has entered. For example, if the user terminal 100 enters the customized region 60, 70, the module for object recognition of the user terminal 100 may be turned on or initiated, and accordingly the user terminal 100 may recognize the object within the space 5 or the customized region 60, 70. If the user terminal 100 leaves the customized region 60, 70, the module for object recognition of the user terminal 100 may be turned off or disabled again. However, although the user terminal 100 leaves the customized region 60, 70, controlled settings may be maintained depending on some example embodiments.

According to this example embodiment, the user terminal 100 does not indiscriminately recognize and detect objects in all areas within the space 5 and may recognize and detect an object only in a specific customized region or only after entering the specific customized region. Therefore, considering the user's movement line and field of view or perspective within the space 5 (in terms that the customized region may be a 3D space with a height range), the service associated with the space 5 may be efficiently provided to the user terminal 100.

The module for object recognition may be, for example, a module for vision object tracking (VOT). In some example embodiments, the module for object recognition may be a component used for object recognition using a smart lens of the user terminal 100. This module may be a portion of the processor 120, or may be implemented separately within the user terminal 100. Also, this module may be a software module executed by the processor 120.

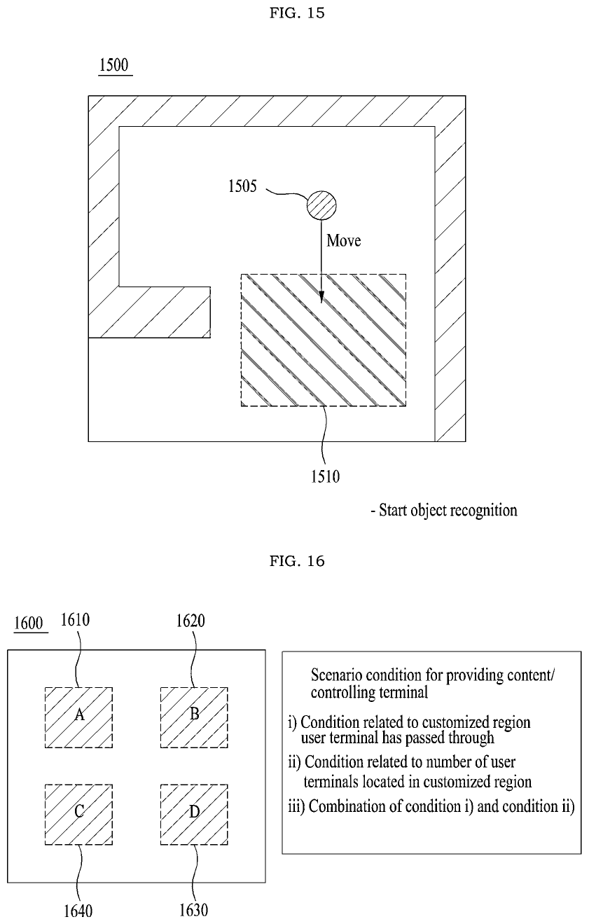

In this regard, FIG. 15 illustrates a method of controlling settings of a user terminal in response to the user terminal being located in a desired (or alternatively, preset) customized region according to an example embodiment.

As illustrated, a customized region 1510 may be configured in a space 1500, and when the user terminal 100 enters the customized region 1510 from a location 1505, settings of the user terminal 100 may be controlled to turn on or initiate the module for object recognition of the user terminal 100.

Through this example embodiment, it is possible to resolve complexity of a user interface, an increase in cognitive load of the user, and an increase in load of the user terminal 100 caused by too much content augmented through the AR view 10. In other words, the settings of the user terminal 100 may be controlled and/or content augmented through the AR view 10 may be appropriately selected based on a service element associated with a customized region 60, 70, thereby enabling efficient use of a video/screen of the AR view and/or reducing undesirable excessive consumption of processing resources.

In relation to controlling settings of the user terminal 100, various scenario conditions that may be defined in the customized region 60, 70 are further described below with reference to FIGS. 5 to 8.

Description related to the technical features described above with reference to FIGS. 1 to 3 and FIGS. 12 and 13 may also be applied as is to FIG. 4, FIGS. 9 to 11, and FIGS. 14 and 15 and thus, repeated description is omitted.

Also, the scope of example embodiments is not limited to specific examples described with reference to the drawings.

FIG. 5 is a flowchart illustrating a method of creating a customized region according to an example embodiment.

A method of defining the aforementioned customized region 60, 70 on data representing the space 5 (e.g., map of the space 5), associating a service element with the customized region 60, 70, and defining a scenario condition for providing the service or information associated with the space 5 to the user terminal 100 or controlling settings of the user terminal 100 is described with reference to FIG. 5.

The customized region 60, 70 may be created using a customized region creation tool by an administrator terminal, which is described below. The customized region creation tool may be a program installed on the administrator terminal or a portion of the program, or may be a program installed on the server 200 or a portion of the program. The customized region creation tool refers to, for example, an authoring tool for creating the customized region 60, 70 for the space 5 in order to provide a location-based AR service, and may allow 3D content such as AR content to be created, augmented, and displayed on the user terminal 100 by setting an area corresponding to the customized region 60, 70, by setting a desired (or alternatively, predetermined) scenario condition (e.g., spatial condition) in the area corresponding to the customized region 60, 70, and by associating a specific service element with the area. That is, the customized region creation tool may have a function of setting 2D space and/or 3D space as the area corresponding to the customized region 60, 70, and by associating the set area with a service for outputting the 3D content. The customized region creation tool may manage each of the customized regions 60 and 70 using a unique ID. Through the ID of each of the customized regions 60 and 70, an area corresponding to each of the customized regions 60 and 70 may be managed in association with the scenario condition.

Meanwhile, the customized region creation tool may include an indoor map creation tool, or may configure a portion of the indoor map creation tool.

The following operations 510 to 530 may be performed through the customized region creation tool.

In operation 510, the terminal or the server 200 may define the customized region 60, 70 including at least one of 2D space or 3D space on data representing the space 5 (e.g., map of the space 5). The server 200 may be a device that manages (e.g., register, change, delete, store, and/or maintain) the customized region 60, 70, and may be a map server that provides a digital map (3D map and/or 2D) or may include this map server.

The area corresponding to the customized region 60, 70 may be set within the space 5 according to an absolute coordinate system. Setting the area corresponding to the customized region 60, 70 may be performed by at least one of an input of coordinate values corresponding to the area, a selection of a point, or a selection by dragging the area.

Data representing the space 5 refers to data rendered on a UI of the customized region creation tool and may include at least one of the map of the space 5, point cloud data (PCD) collected for the space 5, or a captured image of the space 5. At least two of them may be overlappingly displayed on the UI of the customized region creation tool.

The terminal may be a terminal of a service provider used to define the customized region 60, 70 on the map of the space 5. The terminal may be the aforementioned administrator terminal distinguished from the user terminal 100 that receives the service and content, that is, displays the content and information. A structure of the administrator terminal may be similar to the computer system 2 described above with reference to FIG. 2, and thus repeated description is omitted. Through the administrator terminal, the service provider may define the customized region 60, 70 on the data representing the space 5, such as the map. If the customized region 60, 70 is defined through the administrator terminal, it may be registered to the server 200.

However, depending on some example embodiments, the aforementioned user terminal 100 may be used to define the customized region 60, 70 on data representing the space 5 (e.g., map of the space 5). That is, even the user terminal 100 that is provided with a service for the space 5 may also define the customized region 60, 70 for providing the service for the space 5. Here, the service for the space 5 may be based on cloud sourcing of the user terminals 100.

Also, at least one location or at least one area within the space 5 for creating the customized region 60, 70 within the space 5 may be sold to the user terminal 100. The user terminal 100 may purchase the location or the area for creating the customized region 60, 70 through the server 200, and may create the customized region 60, 70 in the purchased location or area. Therefore, the user terminal 100 may create its own customized region 60, 70 in the location or the area purchased by the user terminal 100, thereby allowing desired (or alternatively, predetermined) AR content to be displayed through an AR view of another user terminal located in the corresponding customized region 60, 70, or allowing the other user terminal to be controlled according to a scenario condition of the customized region 60, 70. In this example embodiment, a location or an area that the user terminal 100 may purchase may belong to a partial area of the space 5 permitted by the service provider, rather than the entire range of the space 5. That is, the user terminal 100 may personalize creation of the customized region 60, 70 by purchasing the location or the area (e.g., location or area of which sales are permitted) that belongs to the partial range of the space 5 permitted by the service provider.

The terminal may define the customized region by selecting an area desired to designate as the customized region 60, 70, by inputting coordinates corresponding to the area, or by drawing the area on the data representing the space 5 (e.g., map of the space 5).

The defined customized region 60, 70 may be displayed on the map of the space 5 in the administrator terminal.

In operation 520, the terminal or the server 200 may associate at least one service element with the customized region 60, 70 defined in operation 510. An identifier (ID) may be assigned to each of the defined customized regions 60 and 70, and the service element may be connected to the identifier of each of the customized regions 60 and 70.

In an example embodiment, a plurality of customized regions may be defined on the map of the space 5, and an identifier may be assigned to each of the customized regions. At least one service element may be connected to the identifier of each of the customized regions. The service element individually matches the ID of the customized region. Therefore, although customized regions partially overlapping each other on the space 5 are defined, the user terminal 100 may be correctly controlled by the customized regions.

The service element may include data for performing at least one of displaying content on the AR view 10 of the user terminal 100, displaying a UI related to a service on the user terminal 100, displaying map element content on a map of the user terminal 100, or controlling settings of the user terminal 100 to provide a service to the user terminal 100, with respect to the user terminal that enters the set customized region 60, 70.

In operation 530, the terminal or the server 200 may define (set) a scenario condition for providing the service or information associated with the space 5 to the user terminal 100 in the defined customized region 60, 70 based on the service element or controlling settings of the user terminal 100 based on the service element.

This scenario condition is a condition for controlling the user terminal 100, and may include a condition for providing the service or information associated with the space 5 or controlling settings of the user terminal 100.

Through operations 510 to 530, the service element is associated with the customized region 60, 70, the scenario condition is defined, and accordingly, the customized region 60, 70 may be set (created) on the map of the space 5.

The created customized region 60, 70 may cause the user terminal 100 to be controlled based on the associated service element, when the location of the user terminal 100 is present in the customized region 60, 70 on the map (or determined to leave the customized region 60, 70). Also, the created customized region 60, 70 may cause the service or information associated with the space 5 to be provided to the user terminal 100 based on the service element or may cause the settings of the user terminal 100 to be controlled, according to the scenario condition defined in the customized region 60, 70.

In some example embodiments, a scenario or a scenario condition is defined for each service element and may be a portion of the service element. That is, the service element associated with the customized region 60, 70 may include the scenario or the scenario condition.

As described above, operations 510 to 530 may be performed through the aforementioned program or application that runs on the administrator terminal or the user terminal 100, and includes the customized region creation tool for creating (setting) the customized region 60, 70.

Meanwhile, creation of the customized region 60, 70 may be performed in such a manner that an administrator possessing a specific measurement terminal directly scans the space 5. The measurement terminal may be included in the administrator terminal, or may be a separate device. Here, a desired (or alternatively, predetermined) range area may be defined as the customized region 60, 70 based on positioning of the measurement terminal within the space 5. Positioning of the measurement terminal may use a method by visual localization, a method by a VPS, a method by recognizing a marker, a method of using a GPS, a method of using a WPS, a method of using a Bluetooth module, and a method of using odometry. Based on an area and/or object recognized according to positioning of the measurement terminal, the customized region 60, 70 may be defined on the map of the space 5. That is, creation of the customized region 60, 70 may be performed by a method of directly scanning the space 5 using the administrator terminal. This method may also be used with the aforementioned method of using the customized region creation tool. The customized region creation tool may be used to change and adjust the automatically defined area and to set the scenario condition.

Meanwhile, the created customized region 60, 70 may be displayed not only on the map of the administrator terminal but also the map view 20 of the user terminal 100. Therefore, the user of the user terminal 100 may easily identify the customized region 60, 70 through the map view 20.

Description related to the technical features described above with reference to FIGS. 1 to 4 and FIGS. 9 to 14 may also be applied as is to FIG. 5 and thus, repeated description is omitted.

Also, the scope of example embodiments is not limited to specific examples described with reference to the drawings.

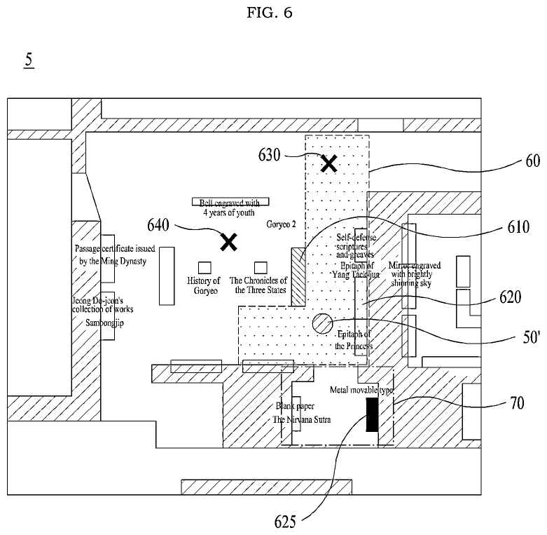

FIG. 6 illustrates a map in which a customized region is defined according to an example embodiment.

The created customized regions 60 and 70 are further described with reference to FIG. 6.

In the illustrated example, the first customized region 60 and the second customized region 70 are defined within the space 5.

The illustrated customized region 60, 70 may be set in consideration of an occlusion area for the user terminal 100 within the space 5.

For example, in an example embodiment, describing with reference to the example of FIG. 1, only when the user terminal 100 enters the first customized region 60, AR content may be displayed at a location 625 of object “Metal movable type” and/or a location 620 “Epitaph of the Princess” within the AR view 10. That is, when the user terminal 100 is present at a location 630, the AR content may be displayed at the location 620 and/or the location 625 of the object within the AR view 10. However, when the user terminal 100 is present at a location 640, the AR content is not displayed within the AR view 10.

When the user terminal 100 is located at the location 640, a structure 610 may be an occlusion area for the user terminal 100. Although the user terminal 100 is present at the location 640, the AR content may be displayed at the location 620 and/or location 625 of the object within the AR view 10. In this case, the AR content may be displayed in the occlusion area and it is inappropriate.

According to an example embodiment, the customized region 60, 70 may be set in consideration of the occlusion area by structures within the space 5. Only when the user terminal 100 is located in the customized region 60, 70, the AR content may be displayed on the AR view 10, which may lead to improving the quality of AR content provided through the AR view 10.

Therefore, in an example embodiment, compared to a “rendering range” based method of displaying the AR content based on a distance or a radius from the location 620 and/or location 625 of the object or a “semantic range” based method of segmenting the space 5 into semantic unit areas and displaying the AR content when the user terminal 100 enters the unit space, it is possible to display the AR content on the user terminal 100 in a more user friendly and natural manner by utilizing a “custom range” method of using a customized region associated with a service element and in which a scenario condition is defined to display the AR content.

In the case of utilizing the “rendering range” based method or the “semantic range” based method, the AR content may be displayed at the location 620 and/or location 625 of the object within the AR view 10 even when the user terminal 100 is present at the location 640. Therefore, the AR content may be displayed in the occlusion area 610 and it is inappropriate.

Description related to the technical features described above with reference to FIGS. 1 to 5 and FIGS. 9 to 15 may also be applied as is to FIG. 6 and thus, repeated description is omitted.

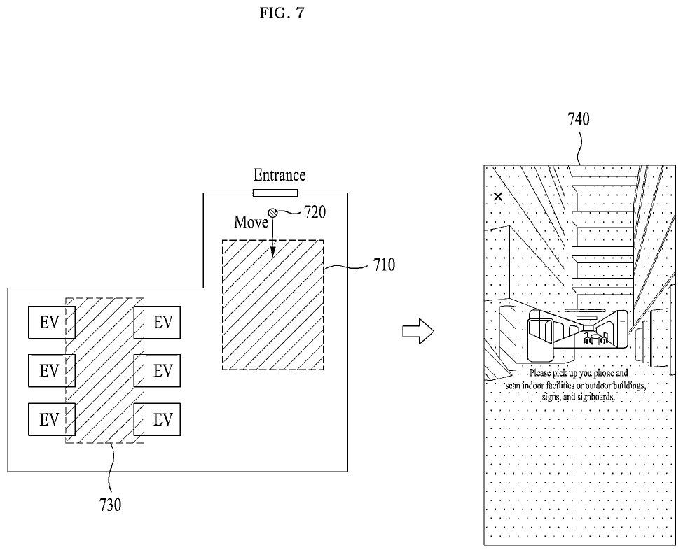

FIG. 7 illustrates a map in which a customized region is defined and an augmented reality (AR) view screen of a user terminal according to an example embodiment.

Created customized regions 710 and 730 are further described with reference to FIG. 7. In the illustrated example, the fifth customized region 710 and the sixth customized region 730 are defined within space.

In the illustrated example, the user terminal 100 may move from a location 720 to the fifth customized region 710. Before the user terminal 100 enters the fifth customized region 710, desired (or alternatively, predetermined) guide information 740 may be displayed on the AR view 10. The guide information 740 may include information on an action to be performed by the user terminal 100 to be provided with an AR navigation service or AR content through the AR view 10.

If the user terminal 100 enters the fifth customized region 710, the AR content may be displayed on the AR view 10 based on a service element associated with the fifth customized region 710. This AR content may be, for example, welcome content displayed on the AR view 10 when initially entering the space. This space may be, for example, a building.

In an example embodiment, if the user terminal 100 is near entrance without passing the entrance, or located immediately after passing the entrance, the fifth customized region 710 may be set at a desired (or alternatively predetermined) distance or more from the entrance such that the welcome content may not be displayed on the AR view 10. Accordingly, it is possible to block or prevent the welcome content from being incorrectly displayed or to block or prevent the field of view of the AR view 10 from being obstructed. Meanwhile, in the case of utilizing the “rendering range” based method or the “semantic range” based method described above, this problem may not be solved.

The sixth customized region 730 may be set in an area near an elevator.

As illustrated, if the user terminal 100 enters the sixth customized region 730 that is the area near the elevator, information (or content) on riding the elevator may be provided to the user terminal 100 based on a service element associated with the sixth customized region 730. Here, if the user terminal 100 is being provided with route guidance to a destination through the AR view 10, guide information (e.g., guide information 1200 of FIG. 12) for moving to the destination may be displayed on the AR view 10.

Description related to the technical features described above with reference to FIGS. 1 to 6 and FIGS. 9 to 15 may also be applied as is to FIG. 7 and thus, repeated description is omitted.

Also, the scope of example embodiments is not limited to specific examples described with reference to the drawings.

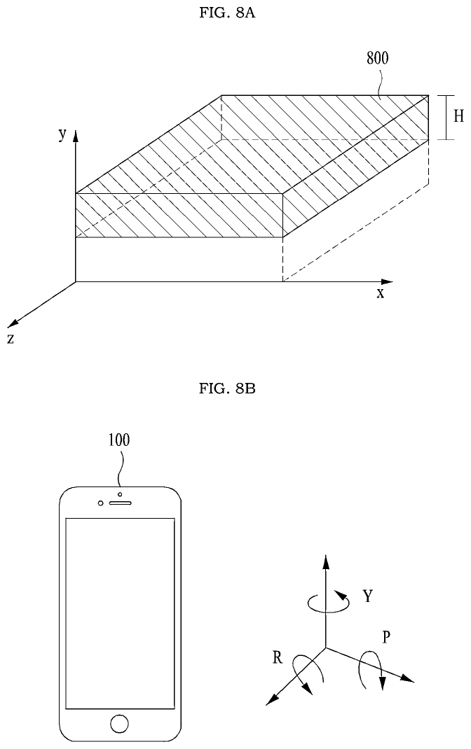

FIG. 8A illustrates a customized region defined as 3D map according to an example embodiment.

In FIG. 8A, a customized region 800 defined as 3D space and a scenario condition defined therein are further described.

The aforementioned customized region 60, 70 may be defined to include at least one of 2D space 3D space on the map of the space 5.

When a location of the user terminal 100 is present in the customized region 60, 70 (or is determined to be outside the customized region 60, 70) on the map, the user terminal 100 or the server 200 may control the user terminal based on a service element associated with the customized region 60, 70.

The customized region 800 may be defined to include the 3D space with a 2D area and a set height range. In some example embodiments, the customized region 800 may be defined as complex dimensional space that includes the 2D space and the 3D space. Defining of this customized region 800 may be performed by the aforementioned operation 510.

The 2D area that constitutes the customized region 800 may include 2D coordinate space (x, z). The height range that constitutes the customized region 800 may include y-axis coordinate space. The height range may be a range (H) with upper limit and lower limit as illustrated, and may be a range without upper limit or lower limit unlike what is illustrated.

When the user terminal 100 is located in the 2D area that constitutes the customized region 800 and the height of the user terminal 100 belongs to the set height range that constitutes the customized region 800, the user terminal 100 or the server 200 may determine that the user terminal 100 is located in the customized region 800 and may control the user terminal 100 based on a service element associated with the customized region 800.

The height of the user terminal 100 may be acquired by a sensor included in the user terminal 100. The height of the user terminal 100 may represent, for example, a height of the camera of the user terminal 100.

Although a single height range (H) is illustrated in FIG. 8A, a plurality of height ranges may be defined in the customized region 800, and a service element may be associated and a scenario condition may be defined for each height range.

As such, by setting the customized region 800 as cubic 3D space, the user terminal 100 may be controlled by a different scenario condition depending on the height of the user terminal 100 although the user terminal 100 is located in the same 2D space.

Hereinafter, the scenario condition defined for the customized region 60, 70 is further described with reference to FIG. 8B.

FIG. 8B illustrates degree of freedom (DoF) of a user terminal according to an example embodiment.

A 3DoF or 6DoF posture condition of the user terminal 100 may be defined in the customized region 60, 70. 6DoF may represent motions in x-axis, y-axis, and z-axis directions, and rotations in x-axis, y-axis, and z-axis directions (roll, yaw, and pitch).

This posture condition may be the scenario condition defined for the customized region 60, 70, and may be included in the service element associated with the customized region 60, 70.

When the user terminal 100 is determined to be present in the customized region 60, 70, the user terminal 100 or the server 200 may control the user terminal 100 based on the service element associated with the customized region 60, 70 if the posture of the user terminal 100 satisfies the posture condition defined in the customized region 60, 70. The posture of the user terminal 100 may be acquired by the sensor, for example, a gyro sensor, included in the user terminal 100.

As this posture condition is defined in the customized region 60, 70, the user terminal 100 may be controlled based on the service element, for example, only when the user terminal 100 enters the customized region 60, 70 and the AR view 10 is maintained at a specific angle or within a specific angle range. For example, AR content that needs to be displayed in a specific area within the customized region 60, 70, for example, at a location above or below a desired (or alternatively, predetermined) height may be displayed on the AR view 10 of the user terminal 100 only when the user terminal 100 enters the customized region 60, 70 and the AR view 10 is maintained at an angle or within an angle range at which a specific area is illuminated above or below the desired (or alternatively, predetermined) height.

Therefore, in an example embodiment, the AR content may be displayed at a more appropriate location and viewpoint of the AR view 10.

Hereinafter, another example of the scenario condition defined for the customized region 60, 70 is further described.

At least one condition among a first condition representing a time condition, a second condition representing movement of the user terminal 100, and a third condition representing manipulation of the user terminal 100 may be defined in the customized region 60, 70.

The first condition may be, for example, that the user terminal 100 stays in the customized region 60, 70 for a desired (or alternatively, predetermined) period of time or more (e.g., 3 seconds or more) or stays in the customized region 60, 70 for a desired (or alternatively, predetermined) period of time or less. In some example embodiments, the first condition may be that the user terminal 100 enters the customized region 60, 70 in a desired (or alternatively, predetermined) time zone or enters the customized region 60, 70 at a time other than the desired (or alternatively, predetermined) time zone. The second condition represents, for example, a physical manipulation of the user terminal 100, and may be that the user terminal 100 is shaken a desired (or alternatively, predetermined) number of times or with desired (or alternatively, predetermined) intensity or more. In some example embodiments, the second condition may be an action of moving the user terminal 100 in a specific shape (e.g., a shape of letter ‘8’). The third condition may be an action of electronically manipulating the user terminal 100 and, for example, may be inputting a specific button or key, inputting a specific gesture, inputting specific voice or audio, and/or capturing a specific object.

When the user terminal 100 is determined to be located in the customized region 60, 70, the user terminal 100 or the server 200 may control the user terminal 100 based on the service element associated with the customized region 60, 70 if the user terminal 100 satisfies the scenario condition that is at least one of the first condition to the third condition. For example, depending on whether the scenario condition is satisfied, the user terminal 100 may differently display the AR content, may differently display a UI, may differently display map element content, and/or may differently control settings of the user terminal 100.

Description related to the technical features described above with reference to FIGS. 1 to 7 and FIGS. 9 to 15 may also be applied as is to FIGS. 8A and 8B and thus, repeated description is omitted.

Also, the scope of example embodiments is not limited to specific examples described with reference to the drawings.

FIG. 16 illustrates a method of setting a plurality of customized regions in space and setting a scenario condition for controlling a user terminal for each customized region according to an example embodiment.

Hereinafter, another example of a scenario condition defined for each of a plurality of customized regions 1610 to 1640 set in space 1600 is further described.

The aforementioned customized region 60, 70 may be one of the customized regions 1610 to 1640.

At least one scenario condition between i) a first scenario condition representing whether the user terminal 100 has passed through desired (or alternatively, predetermined) another customized region rather than the customized region 60, 70 and ii) a second scenario condition representing whether the number of user terminals located in the one customized region corresponds to a desired (or alternatively, predetermined) range may be defined in one customized region 60, 70 among the customized regions 1610 to 1640. Depending on whether the corresponding scenario condition is satisfied, the user terminal 100 may be differently provided with a service or information associated with the space 5, 1600 based on the service element associated with the one customized region 60, 70, or settings of the user terminal 100 may be differently controlled.

The first scenario condition may be a condition that the user terminal 100 having entered the customized region 60, 70 enters the customized region 60, 70 after entering another specific customized region. For example, when the user terminal 100 enters a specific customized region among the customized regions 1620 to 1640 and then enters the customized region 1610 (within a desired (or alternatively, predetermined) period of time), the first scenario condition may be satisfied. In some example embodiments, when the user terminal 100 enters the customized region 1610 (within a desired (or alternatively, predetermined) period of time) after entering at least some of the customized regions 1610 to 1640 in specific order, the first scenario condition may be satisfied. Depending on whether the first scenario condition is satisfied, the user terminal 100 may differently display the AR content, may differently display the UI, may differently display the map element content, or may differently control settings of the user terminal 100.

The second scenario condition may be a condition that the number of user terminals located in the customized region 60, 70 or the cumulative number of user terminals entering the customized region 60, 70 (during a desired (or alternatively, predetermined) period of time) is greater than or equal to a desired (or alternatively, predetermined) number or less than a desired (or alternatively, predetermined) number. In some example embodiments, the second scenario condition may be a condition that the number of user terminals located in another customized region rather than the customized region 60, 70 that the user terminal 100 is entering or the cumulative number of user terminals entering the other customized region (during a desired (or alternatively, predetermined) period of time) is greater than or equal to the desired (or alternatively, predetermined) number or less than the desired (or alternatively, predetermined) number. In some example embodiments, the second scenario condition may be a condition that the number of user terminals located in both the customized region 60, 70 and the other customized region or the number of cumulative user terminals entering both the customized regions (over a desired (or alternatively, predetermined) period of time) is greater than or equal to the desired (or alternatively, predetermined) number or less than the desired (or alternatively, predetermined) number. Depending on whether the second scenario condition is satisfied, the user terminal 100 may differently display the AR content, may differently display the UI, may differently display the map element content, or may differently control settings of the user terminal 100.

The aforementioned first scenario condition and second scenario condition may be used in combination with each other. For example, when the user terminal 100 enters the customized region 60, 70, the user terminal 100 or the server 200 may determine whether the first scenario condition and the second scenario condition are satisfied. Only when both scenario conditions are satisfied, the user terminal 100 may be controlled based on the service element. In some example embodiments, control of the user terminal 100 based on the service element may be differently performed depending on which condition between the first scenario condition and the second scenario condition is satisfied.

Description related to the technical features described above with reference to FIGS. 1 to 15 may also be applied as is to FIG. 16 and thus, repeated description is omitted.

Also, the scope of example embodiments is not limited to specific examples described with reference to the drawings.

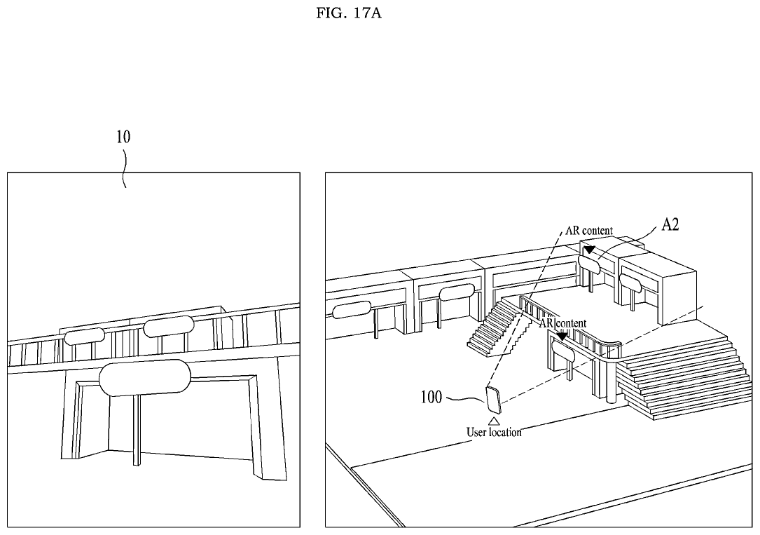

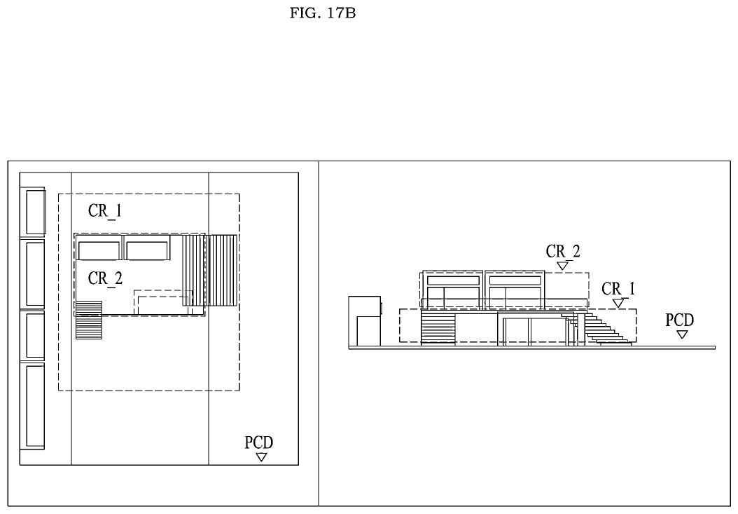

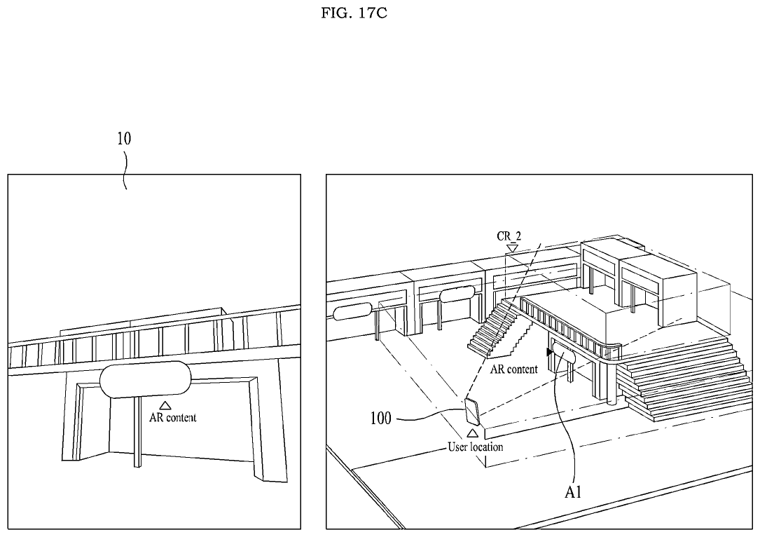

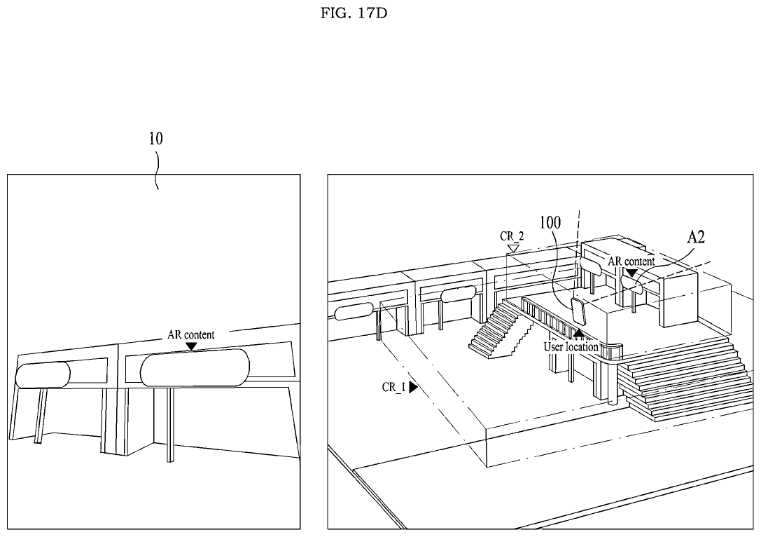

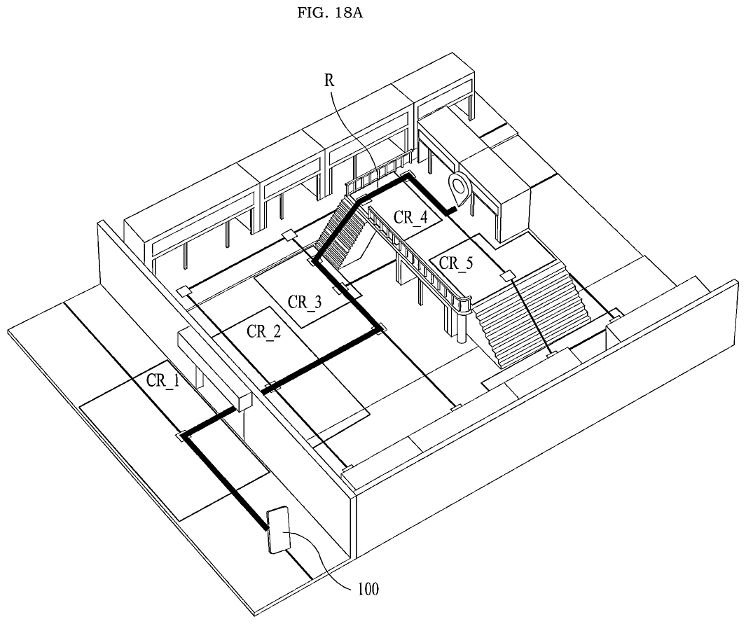

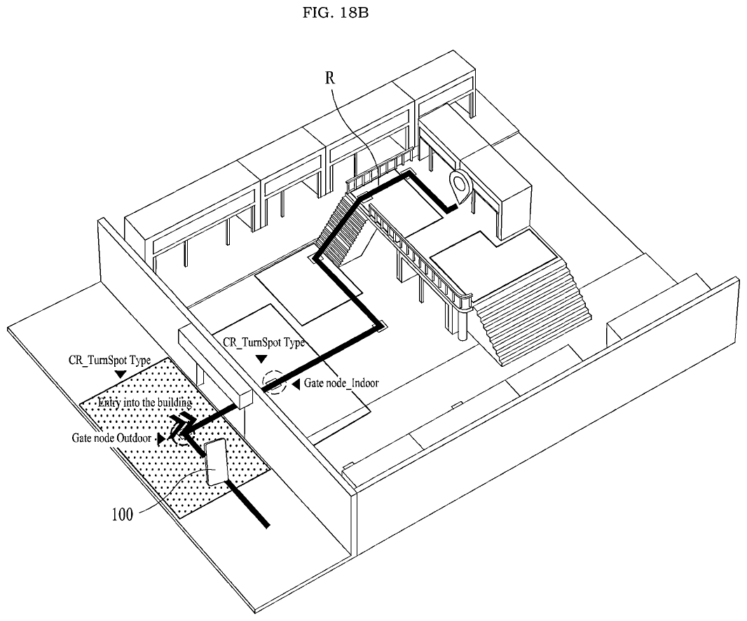

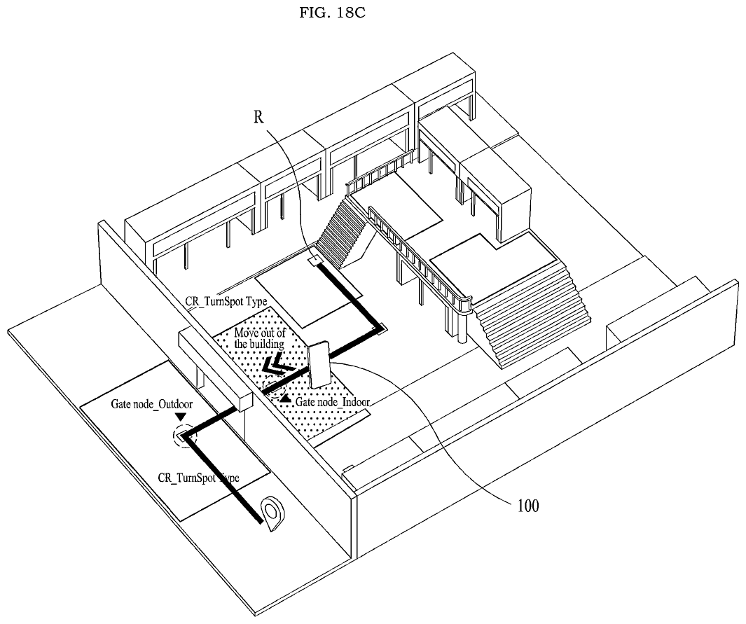

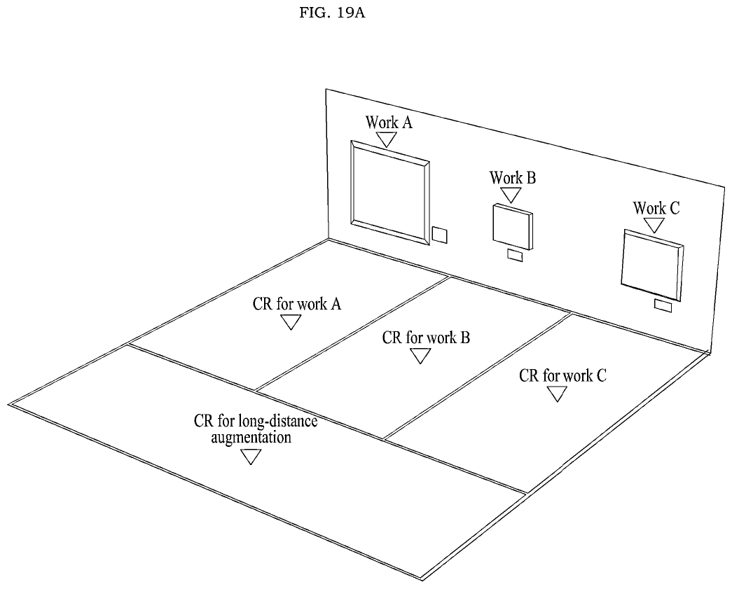

FIGS. 17A to 21C illustrate a method of controlling a user terminal located in a customized region according to various scenario conditions defined for the customized region according to an example embodiment.

Examples of the method of controlling the user terminal 100 using the customized region created through the method of creating the customized region described above are further described with reference to FIGS. 17 to 21.

As described above, a service element associated with the created customized region may include data for displaying AR content related to a service associated with the space. When a user terminal is located in the customized region, the AR content may be displayed through the AR view 10 according to a scenario condition set for the customized region. As such, in examples of FIGS. 17A to 21C, a method of displaying the AR content on the user terminal 100 is further described as a method of controlling the user terminal 100 that has entered the customized region.

FIG. 17A illustrates the AR view 10 and a location of the user terminal 100 in a state in which a customized region of an example embodiment is absent. As illustrated, on the AR view 10, AR content displayed on the first floor of space (e.g., AR content associated with an object located on the first floor) and AR content (A2) displayed on the second floor (e.g., AR content associated with an object located on the second floor). Here, an example of the displayed AR content may be an image and/or text corresponding to a sign. That is, in the example of FIG. 17A, although the user terminal 100 is located on the first floor, even the AR content (A2) on the second floor is displayed on the AR view 10, which makes implementation of the AR view 10 on the user terminal 100 complicated. Burden on the user terminal 100 to implement the AR view 10 of the user terminal 100 may also increase.

FIGS. 17B to 17D illustrate a case in which two customized regions (CR_1 and CR_2) are created in the same space as illustrated in FIG. 17A. Each of the customized regions (CR_1 and CR_2) may be created using the aforementioned customized region creation tool. The customized region (CR_1) may represent the first floor of the space, and the customized region (CR_2) may represent the second floor of the space. Each of the customized regions (CR_1 and CR_2) represents 3D space and may correspond to a rectangular parallelepiped.

As illustrated in FIG. 17C, when the user terminal 100 is located on the first floor and also located in the customized region (CR_1), only the AR content (A1) on the first floor may be displayed on the AR view 10 of the user terminal 100. That is, when the user terminal 100 is located in the customized region (CR_1), the AR content (AR2) on the second floor may not be displayed.

Meanwhile, as illustrated in FIG. 17D, when the user terminal 100 is located on the second floor and also located in the customized region (CR_2), only the AR content (AR2) on the second floor may be displayed on the AR view 10 of the user terminal 100. That is, when the user terminal 100 is located in the customized region (CR_2), the AR content on the first floor may not be displayed. Depending on example embodiments, AR content on the first floor may be displayed within the AR view 10 only when the user terminal 100 is positioned to look down (e.g., only when maintaining the posture of locating the AR view 10 to face the first floor).

As in examples of FIGS. 17C and 17D, as the customized region (CR_1, CR_2) is appropriately defined for each floor, only AR content of the customized region in which the user terminal 100 is located may be displayed on the user terminal 100, based on a location of the user terminal 100.

Meanwhile, in the created customized region, a scenario condition may be set such that different AR content may be displayed through the AR view 10 by distinguishing between a case in which the user terminal 100 enters the customized region and a case in which the user terminal 100 leaves the corresponding customized region. That is, although the user terminal 100 is located in the same customized region, different AR content may be displayed through the AR view 10 when the user terminal 100 enters the corresponding customized region and when the user terminal 100 exits the corresponding customized region.

In this regard, FIGS. 18A to 18C illustrate a case in which six customized regions (CR_1 to CR_5) are created in the same space as illustrated in FIGS. 17A to 17C.

As illustrated, in addition to the customized regions (CR_1 to CR_5), a plurality of nodes may be defined within the space. A line that connects the nodes may be named “link.” The defined nodes and links may be used to guide a route to a desired (or alternatively, predetermined) destination for the user terminal 100. The plurality of nodes may be defined within each of the customized regions (CR_1 to CR_5).

In FIGS. 18A to 18C, a route (R) through which the user terminal 100 moves according to this route guidance. The route (R) may be provided to the user terminal 100 as route guidance information.

A service element associated with each customized region may be associated with at least one node within the corresponding customized region.

The scenario condition of the customized region may be set such that different AR content may be displayed through the AR view 10 when the user terminal enters the customized region or when the user terminal 100 leaves the customized region, while the user terminal 100 moves according to the route guidance to the destination, that is, moves along the route (R) presented through the route guidance.

Here, whether the user terminal enters the customized region or whether the user terminal 100 leaves the customized region may be determined based on the route (R) presented to the user terminal according to the route guidance. That is, the user terminal 100 or the server 200 may verify which node the user terminal 100 has already passed through or which node the user terminal 100 will pass through based on the route (R), and accordingly may determine whether a current location of the user terminal 100 is present within the customized region or outside the customized region.

For example, as in the example illustrated in FIG. 18B, the user terminal 100 may be determined to have entered the customized region (CR1) based on the current location of the user terminal 100 or the route (R) through which the user terminal 100 has already moved or will move. Here, in the AR view 10 of the user terminal 100, AR content including an arrow indicator toward an entrance door with text “Entry into the building” may be displayed. This AR content may be displayed in association with a specific node (Gate node) within the customized region (CR1). In the illustrated example, the customized region (CR1) may be outdoors and the customized region (CR2) may be indoors.

When the user terminal 100 enters the customized region (CR2), information related to indoor space, including the customized region (CR2) may be displayed in the AR view 10 as the AR content. In some example embodiments, content such as “Welcome” may be displayed through the AR view 10. Meanwhile, as illustrated in FIG. 18C, the user terminal 100 may be determined to exit the customized region (CR2) based on the current location of the user terminal 100 and the route (R) through which the user terminal 100 has already moved or will move. Here, in the AR view 10 of the user terminal 100, AR content including an arrow indicator toward the entrance door along with text “Move out of the building” may be displayed. This AR content may be displayed in association with a specific node (Gate node) within the customized region (CR2).

As such, in an example embodiment, an entry/exit status of the user terminal 100 for a specific customized region may be determined according to a travel route provided to the user terminal 100, and accordingly appropriate AR content may be displayed on the AR view 10.

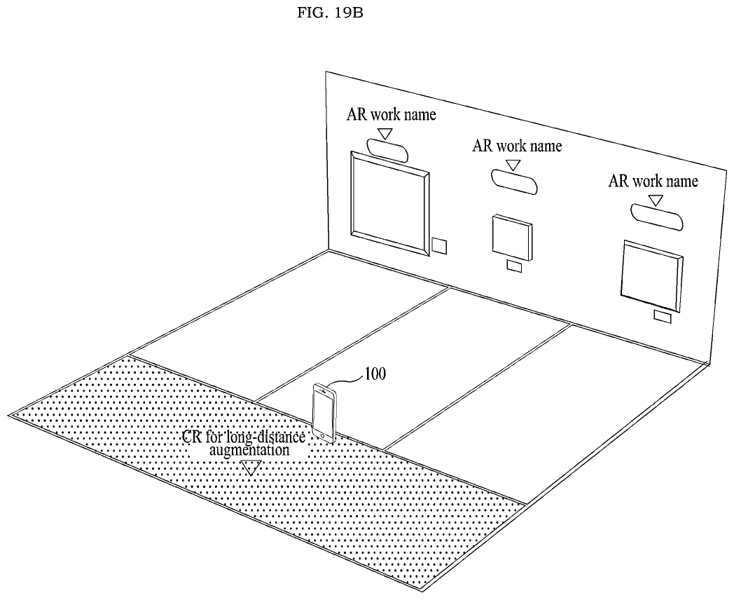

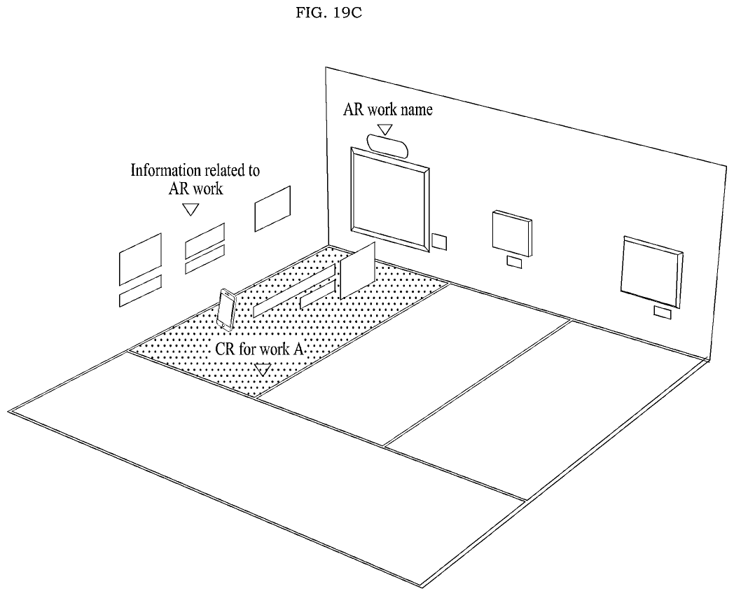

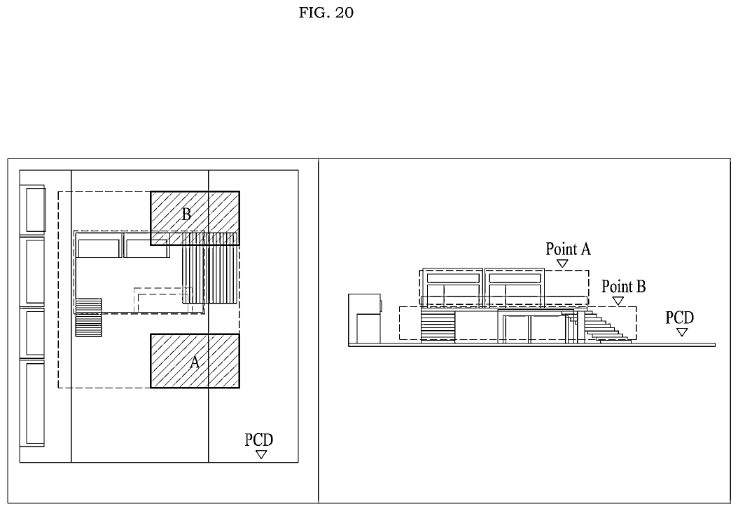

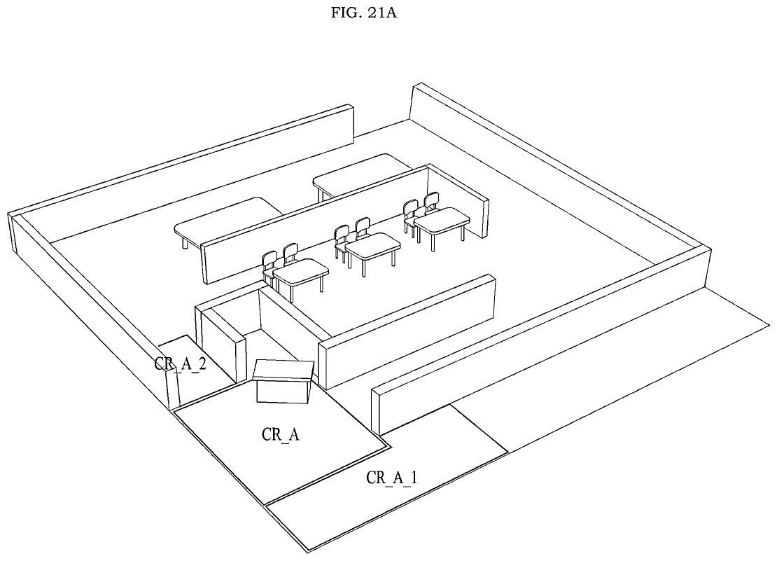

A case in which a plurality of customized regions are defined for a single space (exhibition room space) is further described with reference to FIGS. 19A to 19C. As illustrated, four CRs may be created for a single exhibition room space. It is assumed that three objects, that is, work A, work B, and work C are present in the exhibition room space.

A scenario condition set for a CR for long-distance augmentation relates to displaying, on the AR view 10, AR content that includes first information of work A, work B, and work C in the AR view 10 of the user terminal 100 located in the CR for long-distance augmentation. The first information may include only overview information such as a work name.

Meanwhile, a scenario condition set for a CR for work A may relate to displaying, on the AR view 10, AR content that includes second information of work A in the AR view 10 and, here, disabling all AR content associated with other works. The second information may include richer and more detailed information on the first work than the first information. That is, the user terminal 100 that enters the CR for work A may intensively verify only detailed information on work A associated with the CR for work A. Similar description may also be applied to a CR for work B and a CR for work C.

As such, in an example embodiment, because it is possible to create a plurality of customized regions that output AR content with different information volume for a single space, experience of the user that receives the AR content may be enhanced.

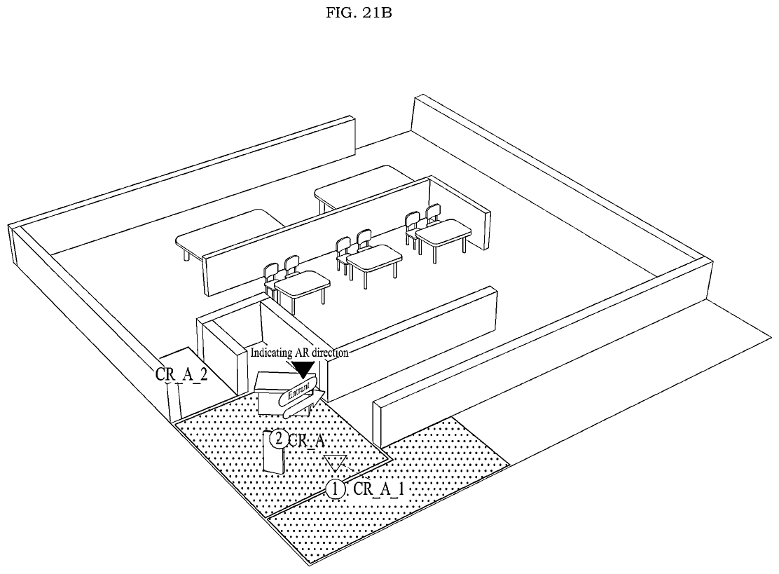

FIG. 20 illustrates a case in which two customized regions are created within the space described with reference to FIG. 17B and a specific point or a subarea is defined in each customized region. For example, a point or a subarea (Point B) may be defined within the customized region (CR_1) corresponding to the first floor and a point or a subarea (Point A) may be defined within the customized region (CR_2) corresponding to the second floor.

A scenario condition set for the customized region (CR_1) may be set to differently display AR content in each of a case of entering the customized region (CR_1) through the specific point or the subarea (Point B) and other cases, a case of exiting the customized region (CR_1) through the specific point or subarea (Point B) and other cases, a case of entering the customized region (CR_1) through the other customized region (CR_2) and other cases, and a case of entering the customized region (CR_1) through the specific point or subarea (Point A) of the other customized region (CR_2) and other cases.

That is, the scenario condition may be set such that, when the user terminal 100 is located in the customized region, AR content determined based on another customized region that the user terminal 100 has entered/passed through before the user terminal 100 enters the corresponding customized region may be displayed through the AR view 10. In some example embodiment, the scenario condition may be set such that, when the user terminal 100 is located in the customized region, the AR content determined based on a point through which the user terminal 100 has passed may be displayed through the AR view 10.

The aforementioned “determined AR content” refers to displaying the existing AR content by applying a different form, different animation, or different effect, to displaying AR content with different content, or to adding additional content (voice, text, image, and video) to the existing AR content.

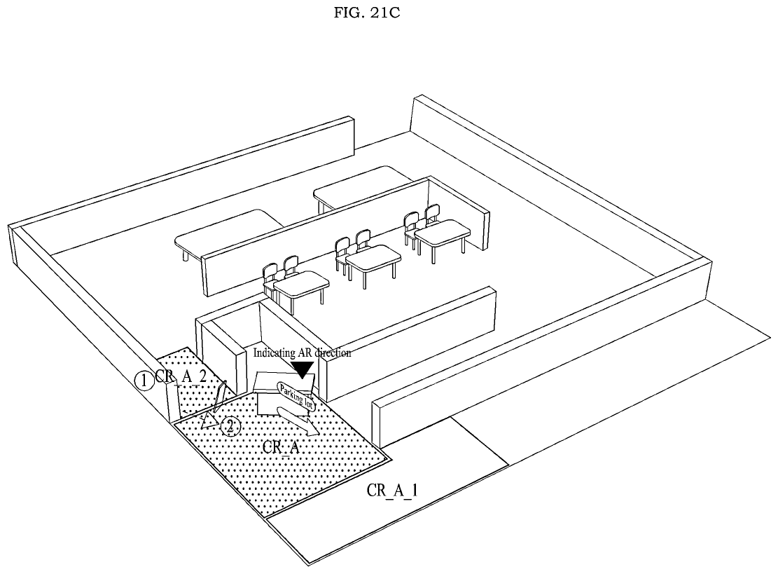

A method of differentiating AR content displayed through the AR view 10 in consideration of the directionality of the user terminal 100 is described with reference to FIGS. 21A to 21C.

In FIG. 21A, the user terminal 100 has entered a customized region (CR_A) through a customized region (CR_A_1). In FIG. 21B, the user terminal 100 has entered the customized region (CR_A) through a customized region (CR_A_2).

In FIGS. 21B and 21C, the user terminal 100 is located in the same customized region (CR_A). However, in each case, content displayed through the AR view 10 may be different. For example, when the user terminal 100 passes through the customized region (CR_A_1), the user terminal 100 may be determined to enter specific space (restaurant) and AR content guiding entrance to the specific space or an additional service (e.g., recommended menu at the restaurant) may be displayed on the AR view 10. Meanwhile, when the user terminal 100 passes through the customized region (CR_A_2), the user terminal 100 may be determined to have left the specific space (restaurant) and AR content guiding outdoors or parking lot or an additional service (e.g., information on other dessert cafes) may be displayed on the AR view 10.

As another example, when the user terminal 100 enters specific space (shopping mall) through a customized region that represents a parking lot, the user terminal 100 or the server 200 may determine that the user visits the specific space through the user's own vehicle as a transportation method. In some example embodiments, when the user terminal 100 enters the specific space (shopping mall) through a customized region that represents entrance to a subway station, the user terminal 100 or the server 200 may determine that the user visits the specific space through a public transportation method as a transportation method. Here, when the user terminal 100 enters the customized region within the specific space or leaves the specific space, content that is tailored for the transportation method used by the user may be output through the AR view 10 of the user terminal 100. For example, AR content including route information to the parking lot and information on vehicle items may be provided to the user using the vehicle or AR content including route information to the subway station may be provided to the user using the public transportation.

Description related to the technical features described above with reference to FIGS. 1 to 16 may also be applied as is to FIGS. 17A to 21C and thus, repeated description is omitted.

Also, the scope of example embodiments is not limited to specific examples described with reference to the drawings.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, a computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The methods according to the example embodiments may be configured in a form of program instructions performed through various computer methods and recorded in computer-readable media. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of other media may include record media and storage media managed by an app store that distributes applications or a site that supplies and distributes other various types of software, a server, and the like.

Although some example embodiments are described with reference to accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A method of controlling a user terminal, performed by a computer system that is a server or the user terminal, the method comprising:
determining whether the user terminal is located within a customized region of a space based on a location of the user terminal, the customized region being associated with at least one service element; and
in response that the user terminal is determined to be located in the customized region, controlling the user terminal based on the service element.

2. The method of claim 1, further comprising:
defining the customized region to include at least one of two-dimensional (2D) space or three-dimensional (3D) space on a map of the space,
wherein the controlling of the user terminal comprises controlling the user terminal based on the service element when the location of the user terminal is present in the customized region on the map.

3. The method of claim 1, wherein
the customized region includes 3D space with a 2D area and a height range, and
the controlling of the user terminal comprises, when the user terminal is located in the 2D area and a height of the user terminal belongs to the height range, determining that the user terminal is located in the customized region and controlling the user terminal based on the service element.

4. The method of claim 1, further comprising:
defining a 3 degree of freedom (DoF) posture condition or a 6DoF posture condition of the user terminal in the customized region,
wherein the controlling of the user terminal comprises, when the user terminal is determined to be located in the customized region, controlling the user terminal based on the service element if posture of the user terminal satisfies at least one of the 3DoF posture condition or the 6DoF posture condition.

5. The method of claim 1, further comprising:
defining at least one condition among a first condition representing a time condition, a second condition representing movement of the user terminal, and a third condition representing manipulation of the user terminal in the customized region,
wherein the controlling of the user terminal comprises, when the user terminal is determined to be located in the customized region, controlling the user terminal based on the service element if the user terminal satisfies the defined condition.

6. The method of claim 1, wherein
the service element includes data for displaying augmented reality (AR) content related to a service associated with the space, and
the controlling of the user terminal comprises, in response to the user terminal being located in the customized region, displaying the AR content through an AR view that includes a video captured by a camera of the user terminal based on the service element.

7. The method of claim 6, wherein
the AR content is associated with a first object located in the customized region and is displayed within the AR view corresponding to the customized region, or
the AR content is associated with a second object located in a remote area for the customized region and is displayed within the AR view corresponding to the remote area.

8. The method of claim 6, wherein
the AR content includes a plurality of sequences, and
the displaying of the AR content comprises, when the user terminal is determined to be located within the customized region, displaying different sequences of the AR content through the AR view according to a location of the user terminal within the customized region.

9. The method of claim 6, wherein the displaying of the AR content comprises changing and thereby displaying the AR content displayed through the AR view or outputting additional content, based on at least one of the location of the user terminal within the customized region, a number of entries of the user terminal into the customized region, or an entry and exit status of the user terminal for the customized region.

10. The method of claim 9, wherein, when the user terminal enters the customized region and when the user terminal leaves the customized region, the displaying of the AR content comprise displaying different AR content as the AR content through the AR view.

11. The method of claim 1, wherein
the service element includes data for displaying map element content related to a service associated with the space, and
the controlling of the user terminal comprises, in response to the user terminal being located in the customized region, displaying the map element content through a map view that includes a map including the location of the user terminal, based on the service element.

12. The method of claim 11, wherein the map element content is associated with a first object located in the customized region and displayed in an area corresponding to the customized region of the map view, or is associated with a second object located in a remote area for the customized region and displayed in an area corresponding to the remote area of the map view.

13. The method of claim 1, wherein
the service element includes data for displaying a user interface (UI) related to a service associated with the space, and
the controlling of the user terminal comprises, in response to the user terminal entering the customized region or in response to the user terminal leaving the customized region, displaying the UI on the user terminal based on the service element.

14. The method of claim 1, wherein
the service element includes data for controlling settings of the user terminal to provide a service associated with the space to the user terminal, and
the controlling of the user terminal comprises, in response to the user terminal entering the customized region or in response to the user terminal leaving the customized region, controlling the settings of the user terminal based on the service element.

15. The method of claim 14, wherein the controlling of the settings of the user terminal comprises running a module for recognizing an object within the space or the customized region or suspending running of the module.

16. The method of claim 1, wherein
a scenario condition for providing a service or information associated with the space to the user terminal based on the service element or controlling settings of the user terminal is defined in the customized region based on the service element, and
the controlling of the user terminal comprises controlling the user terminal such that the service or the information associated with the space is provided to the user terminal based on the service element or the settings of the user terminal, according to the scenario condition.

17. The method of claim 16, wherein
a plurality of customized regions are set in the space, and
the scenario condition is defined in the customized region to differently provide the service or the information associated with the space to the user terminal based on the service element or to differently control the settings of the user terminal, depending on whether at least one scenario condition is satisfied between i) a first scenario condition representing whether the user terminal has passed through another customized region rather than the customized region and ii) a second scenario condition representing whether a number of user terminals located in the customized region corresponds to a range.

18. The method of claim 16, wherein
the service element associated with the customized region includes a plurality of service elements,
the plurality of service elements are associated with different points within the customized region, respectively, and
in the customized region, the scenario condition is defined to differently provide the service or the information associated with the space in order in which the user terminal passes through a point associated with each of the plurality of service elements.

19. The method of claim 1, further comprising:
receiving, from the user terminal, a route guidance request to a destination; and
providing a route guidance to the user terminal in response to the route guidance request,
wherein the determining and the controlling of the user terminal is performed when the user terminal moves to the destination according to the route guidance.

20. A computer system that implements a user terminal or a server, the computer system comprising:
at least one processor configured to execute computer-readable instructions included in a memory,
wherein the at least one processor is configured to
determine whether the user terminal is located within a customized region based on a location of the user terminal, the customized region being associated with at least one service element, and
in response that the user terminal is determined to be located in the customized region, control the user terminal based on the service element.
